(19) United States
(12) Patent Application Publication
(10) Pub. No.: US 2024/0362717 A1
(43) Pub. Date: Oct. 31, 2024

(54) Content Distribution and Management Systems and Methods Using Cryptographic Tokens

(71) Applicant: Intertrust Technologies Corporation, Berkeley, CA (US)

(72) Inventors: Yutaka NAGAO, San Jose, CA (US); Vishisht Tiwari, Sunnyvale, CA (US); Jayant Kannadkar, Sunnyvale, CA (US); Guido CUGI, Cupertino, CA (US); David Choulex, Kawasaki (JP); Talal Shamoon, Berkeley, CA (US); Albhy Galuten, Santa Monica, CA (US)

(73) Assignee: Intertrust Technologies Corporation, Berkeley, CA (US)

(21) Appl. No.: 18/648,113

(22) Filed: Apr. 26, 2024

Related U.S. Application Data
(60) Provisional application No. 63/499,170, filed on Apr. 28, 2023.
(60) Provisional application No. 63/572,861, filed on Apr. 1, 2024.

(51) Int. Cl. G06Q 40/06

(52) U.S. Cl. CPC G06Q 40/06

(57) ABSTRACT

Embodiments of the disclosed systems and methods provide for the management of digital assets and associated asset distribution architectures. Assets may be associated with digital tokens which may be used in connection with various disclosed management paradigms. Marketplace service and token rights management services are described that facilitate, among other things, payment from consumers and/or other parties to artists and/or rightsholders, interactions with media services including content distribution network(s) and/or packaging services, management of rights to digital assets using key management and/or DRM services and/or blockchain services, which may be used to manage associated tokens using trusted ledgers and/or blockchains. In addition, fractional ownership rights may be associated and managed in connection with digital assets, enabling multiple parties to acquire shares in digital assets and be remunerated based on the consumption of such assets.

### CROSS-REFERENCE TO RELATED APPLICATIONS

This application claims the benefit of priority under 35 U.S.C. § 119 (e) to U.S. Provisional Application No. 63/499,170, filed Apr. 28, 2023, and entitled “Fractional Cryptographic Token Rights Management Systems and Methods Using Trusted Ledgers,” and to U.S. Provisional Application No. 63/572,861 filed Apr. 1, 2024, and entitled “Content Distribution and Management Systems and Methods,” both of which are hereby incorporated by reference in their entirety.

### COPYRIGHT AUTHORIZATION

Portions of the disclosure of this patent document may contain material which is subject to copyright protection. The copyright owner has no objection to the facsimile reproduction by anyone of the patent document or the patent disclosure, as it appears in the U.S. Patent and Trademark Office patent file or records, but otherwise reserves all copyright rights whatsoever.

### SUMMARY OF THE INVENTION

The present disclosure relates generally to systems and methods for managing and distributing digital assets. More specifically, the present disclosure relates to systems and methods for managing the distribution of digital assets, which may recognize fractional ownership and/or other interest rights, in a marketplace using trusted ledgers and cryptographic tokens.

Many conventional content distribution paradigms, including music distribution channels, are generally centralized in nature. For example, the world of content and media distribution and governance has steadily come under the control of a few powerful aggregators. This centralized nature may result in less control by artists and other content creators as well as by consumers who ultimately enjoy their content.

Embodiments of the disclosed systems and methods enable artists, creators, and/or content rightsholders (which may be generally referred to interchangeably herein, but may not necessarily all be the same entities) to connect with their consumers while reducing the overhead of that connection, reducing the leverage of the gatekeepers. In some embodiments, a governed framework is detailed that can be utilized by creators and consumers with relatively low overhead. The media and its access may be governed by the agreements between the creators and their consumers in a distributed and immutable fashion.

Embodiments of the disclosed systems and methods provide for digital asset distribution and management architectures and associated methods that are more decentralized in nature, allowing for greater control and management by artists, creators, and consumers. This may allow, for example, a consumer to purchase a song or album by an artist and listen to it on multiple devices and an artist to curate a user experience in sharing albums and associated content, tour dates, lyrics, credits, and/or the like, which may be dynamically controlled and/or otherwise managed by the artist.

In various embodiments, non-fungible tokens (“NFTs”) may be used to manage assets. An NFT is a type of cryptographic token on a trusted ledger (e.g., a blockchain ledger, which may be distributed) that may represent and/or otherwise be associated with an asset, which may comprise a digital asset and/or a physical asset represented by the NFT (the association of which may allow the physical asset to be represented by a digital asset). Embodiments of the disclosed systems and methods may use key management and digital rights management (“DRM”) technologies in connection with NFT management paradigms. For example, using various aspects of the disclosed systems and methods, a consumer can listen to a purchased song, but they may not be able to download the song and upload it on other platforms in violation of the rights to the song, because the purchased song may be protected with DRM techniques. In some embodiments, metadata associated with digital assets may be stored in a server database, and the correlation of digital assets and associated metadata may be securely stored in a trusted ledger, which may comprise a blockchain ledger.

In certain embodiments, marketplace services are described that facilitate, among other things, payment from consumers and/or other parties to artists, creators, and/or rightsholders, interactions with media services including content distribution network(s) and/or packaging services, management of rights to digital assets using key management and/or DRM services and/or blockchain services, which may associate assets (e.g., digital assets and/or physical assets that may be represented digitally) with tokens (e.g., NFTs) that may be managed using trusted ledgers and/or blockchains. In addition, fractional ownership rights may be associated and managed in connection with digital assets in connection with embodiments of the disclosed marketplace services. Fractional ownership models may, among other things, enable multiple parties to acquire shares in content and allowing them to earn revenue based on the financial performance of the content.

Embodiments of the disclosed marketplace services may provide elements of an ecosystem for registering and uploading of content, downloading of content (and/or products which may be represented by digital tokens), creation and/or packaging of digital assets and/or products, listing of content and/or products, delisting of digital assets and/or products, updating of digital assets and/or products, sharing of digital assets and/or products, playback of digital assets and/or products, and/or the like. Further embodiments may facilitate compensation of a rights holder and/or plurality of rights holders associated with content, products, and/or associated NFT(s) based on consumer usage and/or interaction with associated content, products, and/or NFTs.

In various embodiments, artists and consumers may interact with a content distribution service in connection with content distribution, management, and engagement related services. The content distribution service may interface with payment gateway services and/or marketplace services to facilitate, among other things, payment from consumers and/or other parties to artists, creators, and/or rightsholders, interactions with media services, token rights management (“TRM”) services, and/or the like.

As used herein, creatives, creators, artists, and/or the like (which may be used interchangeably herein) may be used to describe songwriters and composers, performers, journalists, videographers, photographers, graphic artists, writers, architects, designers of 3D objects and any other person or group of people and/or machines that create content and/or assets. Content, media, creative works, and/or the like (which may be generally referred to herein in some instances as digital assets) may be used herein to refer to works made by creatives, creators, artists, and/or the like. Embodiments disclosed herein provide tools for artists to distribute their content freely while still controlling their own business use cases and being remunerated directly by their consumers. This may, in some implementations, create closer links between the creator and the consumer.

### BRIEF DESCRIPTION OF DRAWINGS

The inventive body of work will be readily understood by referring to the following detailed description in conjunction with the accompanying drawings, in which:

FIG. 1 illustrates a non-limiting example of a digital asset management ecosystem consistent with certain embodiment disclosed herein.

FIG. 2 illustrates a non-limiting example of a content distribution and management architecture consistent with certain embodiments disclosed herein.

FIG. 3 illustrates non-limiting example of a content distribution and management process consistent with certain embodiments disclosed herein.

FIG. 4 illustrates a non-limiting example of relationships between an artist and various other entities consistent with certain embodiments disclosed herein.

FIG. 5 illustrates a non-limiting example of a process associated with issuing rights licenses consistent with certain embodiments disclosed herein.

FIG. 6 illustrates a non-limiting example of tools used in marketing, promotion, and superdistribution processes consistent with certain embodiments disclosed herein.

FIG. 7 illustrates a non-limiting example of an asset creation process consistent with certain embodiments disclosed herein.

FIG. 8 illustrates a non-limiting example of an asset purchase process consistent with certain embodiments disclosed herein.

FIG. 9 illustrates a non-limiting example of an asset playback process consistent with certain embodiments disclosed herein.

FIG. 10A illustrates a first part non-limiting example of a song token creation process consistent with certain embodiments disclosed herein.

FIG. 10B illustrates a second part non-limiting example of a song token creation process consistent with certain embodiments disclosed herein.

FIG. 10C illustrates a third part non-limiting example of a song token creation process consistent with certain embodiments disclosed herein.

FIG. 10D illustrates a fourth part non-limiting example of a song token creation process consistent with certain embodiments disclosed herein.

FIG. 11A illustrates a first part non-limiting example of a token ownership transfer process consistent with certain embodiments disclosed herein.

FIG. 11B illustrates a second part non-limiting example of a token ownership transfer process consistent with certain embodiments disclosed herein.

FIG. 11C illustrates a third part non-limiting example of a token ownership transfer process consistent with certain embodiments disclosed herein.

FIG. 11D illustrates a fourth part non-limiting example of a token ownership transfer process consistent with certain embodiments disclosed herein.

FIG. 12A illustrates a first part non-limiting example of a song token revenue management process consistent with certain embodiments disclosed herein.

FIG. 12B illustrates a second part non-limiting example of a song token revenue management process consistent with certain embodiments disclosed herein.

FIG. 12C illustrates a third part non-limiting example of a song token revenue management process consistent with certain embodiments disclosed herein.

FIG. 12D illustrates a fourth part non-limiting example of a song token revenue management process consistent with certain embodiments disclosed herein.

FIG. 13A illustrates a first part non-limiting example of a song asset update management process consistent with certain embodiments disclosed herein.

FIG. 13B illustrates a second part non-limiting example of a song asset update process consistent with certain embodiments disclosed herein.

FIG. 13C illustrates a third part non-limiting example of a song asset update process consistent with certain embodiments disclosed herein.

FIG. 13D illustrates a fourth part non-limiting example of a song asset update process consistent with certain embodiments disclosed herein.

FIG. 14A illustrates a first part non-limiting example of a song token revenue update process consistent with certain embodiments disclosed herein.

FIG. 14B illustrates a second part non-limiting example of a song token revenue update process consistent with certain embodiments disclosed herein.

FIG. 14C illustrates a third part non-limiting example of a song token revenue update process consistent with certain embodiments disclosed herein.

FIG. 14D illustrates a fourth part non-limiting example of a song token revenue update process consistent with certain embodiments disclosed herein.

FIG. 15A illustrates a first part non-limiting example of a song token holding retrieval process consistent with certain embodiments disclosed herein.

FIG. 15B illustrates a second part non-limiting example of a song token holding retrieval update process consistent with certain embodiments disclosed herein.

FIG. 15C illustrates a third part non-limiting example of a song token holding retrieval update process consistent with certain embodiments disclosed herein.

FIG. 16A illustrates a first part non-limiting example of a verified song revenue retrieval process consistent with certain embodiments disclosed herein.

FIG. 16B illustrates a second part non-limiting example of a verified song revenue retrieval process consistent with certain embodiments disclosed herein.

FIG. 16C illustrates a third part non-limiting example of a verified song revenue retrieval process consistent with certain embodiments disclosed herein.

FIG. 16D illustrates a fourth part non-limiting example of a verified song revenue retrieval process consistent with certain embodiments disclosed herein.

FIG. 16E illustrates a fifth part non-limiting example of a verified song revenue retrieval process consistent with certain embodiments disclosed herein.

FIG. 17A illustrates a first part non-limiting example of a song information retrieval process consistent with certain embodiments disclosed herein.

FIG. 17B illustrates a second part non-limiting example of a song information retrieval process consistent with certain embodiments disclosed herein.

FIG. 18A illustrates a first part non-limiting example of an investor transaction history retrieval process consistent with certain embodiments disclosed herein.

FIG. 18B illustrates a second part non-limiting example of an investor transaction history retrieval process consistent with certain embodiments disclosed herein.

FIG. 18C illustrates a third part non-limiting example of an investor transaction history retrieval process consistent with certain embodiments disclosed herein.

FIG. 19A illustrates a first part non-limiting example of a retrieval process for song assets owned by an investor using a blockchain ledger consistent with certain embodiments disclosed herein.

FIG. 19B illustrates a second part non-limiting example of a retrieval process for song assets owned by an investor using a blockchain ledger consistent with certain embodiments disclosed herein.

FIG. 19C illustrates a third part non-limiting example of a retrieval process for song assets owned by an investor using a blockchain ledger consistent with certain embodiments disclosed herein.

FIG. 20A illustrates a first part non-limiting example of an asset playback process consistent with certain embodiments disclosed herein.

FIG. 20B illustrates a second part non-limiting example of an asset playback process consistent with certain embodiments disclosed herein.

FIG. 20C illustrates a third part non-limiting example of an asset playback process consistent with certain embodiments disclosed herein.

FIG. 21 illustrates a flow chart of a non-limiting example of a method of managing a digital asset consistent with certain embodiments of the present disclosure.

FIG. 22 illustrates a non-limiting example of a system that may be used to implement certain embodiments of the systems and methods of the present disclosure.

### DETAILED DESCRIPTION OF THE INVENTION

A description of systems and methods consistent with embodiments of the present disclosure is provided herein. While several embodiments are described, it should be understood that the disclosure is not limited to any one embodiment, but instead encompasses numerous alternatives, modifications, and equivalents. In addition, while numerous specific details are set forth in the following description in order to provide a thorough understanding of the embodiments disclosed herein, some embodiments can be practiced without some or all of these details. Moreover, for the purpose of clarity, certain technical material that is known in the related art has not been described in detail in order to avoid unnecessarily obscuring the disclosure.

The embodiments of the disclosure may be understood by reference to certain drawings. The components of the disclosed embodiments, as generally described and/or illustrated in the figures herein, could be arranged and designed in a wide variety of different configurations. Thus, the following description of the embodiments of the systems and methods of the disclosure is not intended to limit the scope of the disclosure, but is merely representative of possible embodiments of the disclosure. Given examples are to be understood as illustrative and non-limiting, whether indicated explicitly as such or not. In addition, the steps of any method disclosed herein do not necessarily need to be executed in any specific order, or even sequentially, nor need the steps be executed only once, unless otherwise specified.

Embodiments of the disclosed systems and methods may provide for dynamic management of digital assets in a secure way, where the rights of rights holders in such assets are respected and/or otherwise enforced. Various embodiments disclosed herein may use trusted ledgers to securely record certain assertions relating to the assets, rightsholders, and/or various ecosystem participants. Such assertions may be used in connection with rights binding, asset and/or content packaging, management, and/or protection operations in connection with a variety of transactions associated with content, products, and/or associated NFTs.

It will be appreciated that, as used herein, the term assets and/or digital assets may be used to generally refer to a wide variety of types of assets. For example, in some embodiments, an asset may comprise a content asset. Content may refer to any media asset, which may be represented as or referenced by (e.g., the entry in the trusted ledger may point to an asset somewhere else, either encrypted or not) an NFT, and may include any type of media content including, for example and without limitation, audio content (e.g., a song), video content, text content, image content, digital contracts, and/or any combinations of the same. In further embodiments, an asset may comprise a physical asset, which may be represented by an NFT (the association of which may allow the physical asset to be represented digitally and managed accordingly).

Assets may be packaged in a variety of ways. For example, content may be individually packaged (e.g., in the form of songs), album based, live-recording based, exclusive in nature (e.g., behind-the-scenes podcasts, early test recordings, and/or the like). Various embodiments and examples herein are described in connection with content assets for purposes of illustration and explanation, but it will be appreciated that such embodiments and/or examples indeed could be used with any type of asset.

As detailed herein, associations between and/or assertions relating to assets and/or tokens may be managed using trusted ledgers, which in some implementations may comprise blockchain ledgers. Certain embodiments may use one or more commercial blockchain ledgers such as, for example and without limitation, the FLOW blockchain, and blockchain connector services to provide mechanisms to readily implement aspects of the disclosed systems and methods with such established blockchain architectures.

In various disclosed embodiments, trusted databases, ledgers, and/or the like (which may be generally referred to herein as “trusted ledgers” and/or variations of the same), may be used to record and/or otherwise manage various assertions associated with digital assets and/or NFTs. In some embodiments, such databases and/or ledgers may be distributed, and may be referred to herein as trusted immutable distributed assertion ledgers (“TIDALs”) and/or variations of the same. In some embodiments, trusted ledgers used in connection with various aspects of the disclosed embodiments may comprise blockchain ledgers. Databases and/or ledgers may, in various embodiments, be public, private, and/or a combination thereof. In certain embodiments, a TIDAL may comprise a public indelible distributed database (“PIDD”). TIDALs consistent with various aspects of the disclosed embodiments may be associated with a variety of properties including, for example, ledger processes that may be resistant to byzantine failures, entries that may be immutable and/or relatively immutable, entries that may be time-synced (at least in part), entries that may be scalable, and/or entries that may be available for relatively fast lookup.

In certain embodiments, consumers can access digital assets through a distribution service (e.g., via a portal and/or an application). In connection with content digital assets, the availability of content for streaming and/or downloading by the service may be determined based on content rightsholder preferences (e.g., rules set by artists). Consistent with embodiments disclosed herein, in some implementations, consumers may have the capability of redistributing digital assets, which in certain instances herein may be referred to as superdistribution. This may allow a media file to be shared among multiple parties, which may need to acquire an associated DRM license to access the content.

In certain embodiments, content rightsholders, creators, and/or artists may have the option to publish their content and/or other assets and/or references to such on social media platforms. Similar to superdistribution models, consumers who discover content on social media platforms may be directed to content distribution services consistent with the disclosed embodiments to obtain DRM licenses which may be required to access, view, and/or otherwise use the content.

Content distribution services consistent with embodiments disclosed herein may support traditional business models by offering consumers the option to purchase content on an à la carte basis and/or through a subscription model. Embodiments disclosed herein also support fractional ownership models, enabling multiple parties to acquire shares in content and allowing them to earn revenue based on the financial performance of the content. Content distribution services may provide users (e.g., artists and/or consumers) with an interface designed to provide an understanding of the trends and/or value of the assets they own and/or otherwise hold rights to. This interface may, in some implementations, facilitate trading of shares in content, enabling users to actively manage their content investments.

In certain implementations, content creators and/or artists, which generally referred to herein as artists, and/or rightsholders (which may or may not be artists) may be provided control of their content. Consumers may be provided control over what they consume via customization of content distribution services and/or associated interfaces. Aspects of the disclosed systems and/or services may facilitate, among other things, interactive experiences between artists and their fans, reward systems and/or collectables (e.g., digital, physical, and/or the like) available through the platform, and/or profiling algorithms which may promote small and larger artists (potentially equally, based on user preferences, and/or based on distribution service promotion goals).

Some embodiments of the disclosed content distribution service may facilitate the offering of different tiers of subscription. A consumer may decide to support their favorite artists by subscribing for a fee to their content. In exchange, they may receive certain rewards and/or content such as, for example and without limitation, redeemable credit for purchasing fractional shares to content, exclusive content available via the content distribution service, early access and/or discounted tickets to live events, limited live recordings, behind the scenes clips, and/or the like. Users may also be offered the option to directly purchase credits, which may be used to, among other things, purchase fractional shares of content assets, redeem and/or cash out credit investments, purchase tickets to live events, and/or the like.

Certain aspects of the disclosed ecosystems, architectures, and/or processes may be performed by and/or otherwise be performed in connection with one or more entities, services, and/or systems that may include, for example and without limitation, one or more of:
Content Distribution Service—A service, which may comprise a front-end service, a back-end service, and a content rights management database, which may be used in connection with managing rights of artists and/or consumers. In certain embodiments, the content distribution service may interface with marketplace services, as detailed below.
User—A user may comprise a user system and/or device that may interact with other entities, systems, and/or services described herein. In some embodiments, the user may be an original rights holder, an owner (e.g., an owner in entirety and/or a fractional owner), a rights holder, a buyer, a renter, and/or a consumer of an asset. In certain instances and examples herein, a user may be generally referred to as an “operator.”
Marketplace Service—An entity and/or service, which may comprise a third-party entity that offers a marketplace service allowing, for example and without limitation, creators and/or rightsholders to upload and/or offer assets on the marketplace in connection with various transactions (e.g., sale, rental, transfer of rights, and/or the like) and/or other entities to interact with the marketplace service to engage in such transactions. In some embodiments, the marketplace service may comprise a third-party service that uses a trusted data management platform (“TIP”) service (or, in certain instances herein, more generally a “trusted data management service”) for NFT and/or DRM implementations. In some embodiments, the marketplace service may include an abstraction layer allowing for streamlined interfacing with the marketplace service by other services.
Trusted Ledger Service—A service that manages a trusted ledger, which in some implementations may comprise a blockchain and/or a TIDAL, in connection with various assertion management interactions (e.g., assertion recordation, assertion verification, etc.) with other systems and/or services. In some embodiments, the blockchain service may comprise a public blockchain service (e.g., the FLOW blockchain) managing a public blockchain. In further embodiments, the blockchain service may comprise a service managing a private blockchain. In some embodiments, the blockchain service may be offered by a token rights management (“TRM”) system and/or service, as described in more detail below. Although various examples described herein may use a blockchain and/or a TIDAL, it will be appreciated that various embodiments and aspects of the disclosed systems and methods may be implemented using a variety of other trusted databases and/or ledgers that may, or may not, have certain attributes associated with a blockchain and/or a TIDAL. The trusted ledger service may further manage a wallet service (which in further implementations could be offered by a separate service) in connection with managing digital wallets (e.g., cryptographic currency wallets) that may be used in connection with various interactions and/or transactions involving the various ecosystems and/or architectures detailed herein.
TRM Service—A TRM service may allow for a marketplace service and/or other entities to interact with various token management services and engage in various transactions and/or interactions involving the ecosystem detailed herein. The TRM service may offer orchestrator services, identity access management (“IAM”) services, DRM and/or key management services (“KMS”) services (e.g., services providing key management functionality including, for example and without limitation, key generation, storage, management, and/or the like), blockchain connector services (e.g., allowing for integration of various systems and/or services with established commercial blockchain and/or digital wallet services), and/or database services, which may be used to store various information relating to assets and/or associated NFTs and/or metadata and/or assist themselves.
Media Service—A service which may be used to package, store, and/or manage the assets, potentially based on interactions with a DRM service and/or TRM service. In various embodiments, packaging assets may comprise one or more of gathering assets, connecting and/or otherwise associated assets with relevant metadata, encoding assets, compressing assets, encrypting assets, storing, managing, and/or otherwise protecting keys associated with the assets, and/or the like. The media service may offer various upload and packaging service (“UaPS”) and/or other file storage and/or database services. In some embodiments, the UaPS service may be used to generate files for adaptive streaming that include manifest file(s) and a plurality of different bitrate files.
Webhook Service—The webhook service may alter certain behavior of a web application and/or page via user-defined HTTP callbacks, which may in some embodiments be event triggered. The behavior of the webhook service may be configured to engage in various actions in response to events and/or invoke certain behaviors.
Graffle Service—A layer over a trusted ledger service (e.g., the FLOW blockchain) that allows developers to query, write, and/or read the blockchain using a variety of languages.
A Content Distribution Network (“CDN”)—A service facilitating the distribution and/or transmission of packaged content (e.g., catalog content and/or streaming media).
Social Media Service(s)—Any suitable service and/or platform offering social media services to artists and/or consumers.
Payment gateway—A service facilitating payment between various services and entities in connection with certain transactions involving content. In some embodiments, the payment gateway may be implemented, at least in part, by a wallet service of the trusted ledger service. In other instances, the payment gateway may facilitate financial transactions between and among individual users of the system, (e.g., to distribute funds between peers in the system).

It will be appreciated that although illustrated and/or described as separate entities, services, and/or systems, one or more of the above-described entities, services, and/or systems may be implemented by a single entity, service, and/or system and/or by any suitable configuration and/or combination of entities, services, and/or systems.

### Marketplace Services and Asset Management

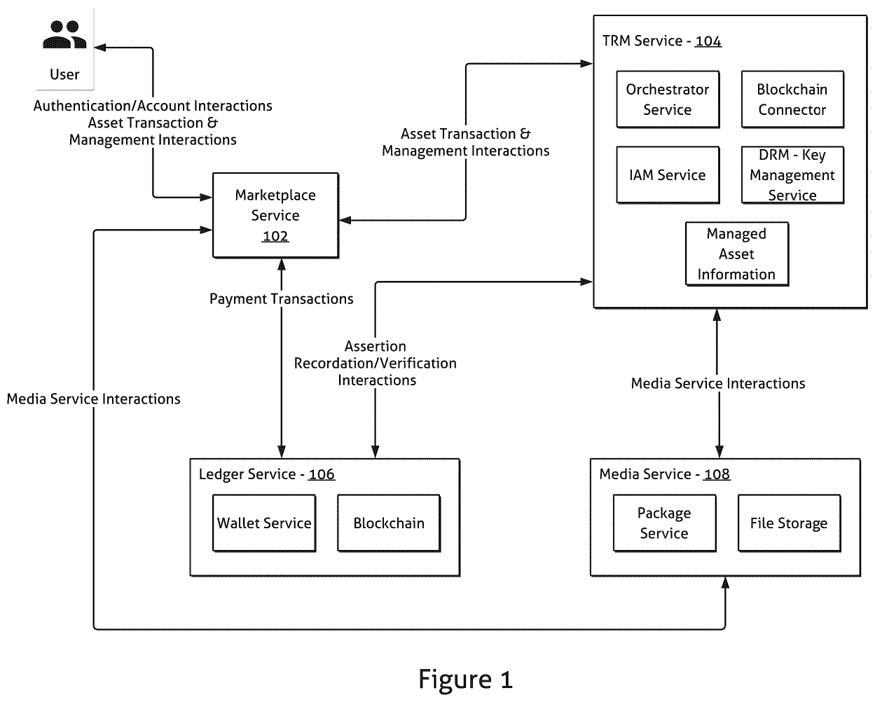

FIG. 1 illustrates a non-limiting example of a digital asset management ecosystem consistent with certain embodiment disclosed herein. As shown, a user may interact with a marketplace service 102 in connection with various asset management interactions and/or interactions. In some embodiments, the user may be an original rights holder, an owner (e.g., an owner in entirety and/or a fractional owner), a rights holder, a buyer, a renter, and/or a consumer of an asset, and/or any other entity interacting with the marketplace service 102. In further embodiments, as discussed in more detail below, other services may interact with the marketplace service 102 including, for example and without limitation, content distribution services.

Users and/or services may among other things, manage their accounts with the marketplace service 102, login and/or authenticate access with the marketplace service 102, and/or engage in a variety of asset and/or content transactions with the marketplace service 102. The marketplace service 102 may interact with the TRM system 104 in connection with a variety of asset and/or NFT management processes consistent with various disclosed embodiments.

The TRM system 104 may include, for example and without limitation, an orchestrator service, an IAM service, a DRM service and/or KMS (which indeed may be the same service), a blockchain connector service facilitating interactions with a trusted ledger and/or ledger service 106, managed asset information, which may comprise a variety of metadata and/or information relating to managed assets, potentially including managed asset files themselves. In connection with various transactions and/or interactions relating to managed assets, the TRM system 104 may interact with a media service 108 and/or a trusted ledger service 106.

The media service 108 may offer certain asset file storage services and/or package services, which may be leveraged by the TRM service 104 (and/or by the marketplace service 102 via the TRM service 104 or directly). For example, in some embodiments, the package service may encrypt asset files and save encrypted asset files on a file store. The package service may further generate asset and/or transaction IDs associated with a managed asset and provide links (e.g., URLs) to allow access to managed assets to permitted parties. Media services 108s and/or associated package services may further allow for digital assets to be packaged into products, serialized, and/or managed in accordance with one or more enforced business conditions.

Business conditions may include permitted actions that may be performed in connection with a digital asset and/or an associated product and may be set by entities that hold certain rights to the digital asset and/or associated product. For example and without limitation, business conditions may be used to manage digital assets and/or associated NFTs based on sell models, rental models, subscription models, rent-ownership models, and/or the like, which may be managed by the marketplace service 102 and/or the TRM service 104.

The trusted ledger service 106 may provide various trusted ledger and/or blockchain and/or cryptographic wallet services which may be leveraged by the marketplace service 102 and/or the TRM service 104 in connection with the disclosed embodiments. For example, a blockchain ledger managed by the ledger service 106 may be used to securely record certain assertions relating to assets, products, rightsholders, and/or various ecosystem participants. Such assertions may be used in connection with rights binding, content packaging, management, and/or protection operations in connection with a variety of transactions associated with digital assets, products, and/or associated NFTs.

Interactions between the marketplace service 102, the TRM service 104, the media service 106, and the ledger service 108 may facilitate a number of asset management interactions and/or transactions including, for example and without limitation, registering and/or uploading of assets and/or NFTs, creation of managed products associated with assets, purchasing and/or accessing assets (e.g., download, playback, etc.) via a variety of access paradigms (e.g., rental, sale, etc.), updating assets and/or products, deleting managed assets and/or products, bundling and/or unbundling assets and/or products, inviting and/or disinviting collaborators to interact with managed assets and/or products, transferring ownership rights of assets, products, and/or associated tokens, including fractional ownership rights and/or other rights (e.g., revenue rights), asset transaction history management, and/or the like.

### Content Distribution Services

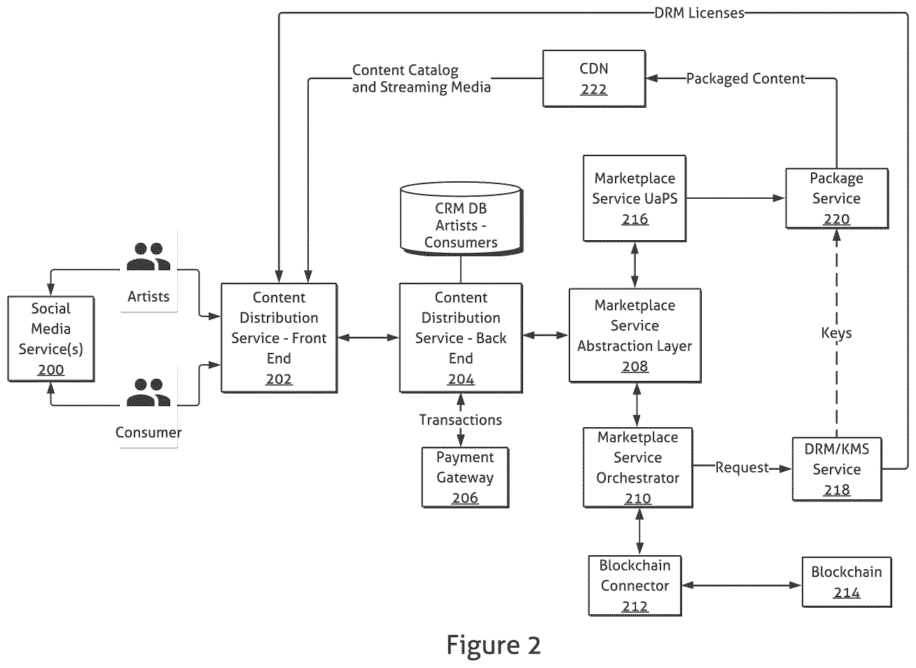

FIG. 2 illustrates a non-limiting example of a content distribution and management architecture consistent with certain embodiments disclosed herein. As shown, artists (which may also be referred to herein as content creators) and consumers may interact with social media platforms and/or services 200. Social media platforms and/or services 200 may be used by artists and consumers in a variety of ways. For example, using these services 200, artists can publish news and promote their work(s), and consumers can discover and interact with new artists (e.g., directly, organically, and/or via recommendation services, and/or via advertising links) and/or with established favorites.

Consistent with embodiments disclosed herein, artists and/or consumers may interact with a front-end service 202 of a content distribution service in connection with various content operations and/or actions. For example and without limitation, artist and/or consumers may interact with a web portal and/or some other suitable application portal and/or interface offered by the front-end service 202. The content distribution service front end service 202 may interact with and/or otherwise share data with a content distribution back-end service 204 in connection with various interactions with other systems and/or services (e.g., marketplace services).

The back-end service 204 may interact with a payment gateway 206 in connection with various artist and/or consumer transactions and/or with a content rights management (“CRM”) database, which may store expressed rights to content associated with artists and/or consumers. For example, the CRM database may provide details regarding access rights for accounts associated with artists and/or consumers that may login and/or otherwise authenticate with the content distribution service. Based on such rights information, the back-end service 204 may enforce such rights (e.g., by granting and/or restricting access to content and/or content management actions requested by artists and/or consumers).

In some embodiments, the payment gateway 206 and/or associated payment services may allow for consumers to remunerate artists and/or other rightsholders (e.g., fractional investors) for songs and/or other content they consume. In some embodiments, the payment gateway 206 may be offered by a ledger service and be configured to implement payment between parties using a cryptographic wallet service system. In further embodiments, other standalone payment services and/or gateway services may be used to facilitate payment between various entities.

The back-end service 204 of the content distribution service may further interact with an abstraction layer 208 of a marketplace service to invoke various services of the marketplace service. For example, the service abstraction layer 208 may allow the back-end service 204 to interact with a marketplace service orchestrator 210, facilitating interactions with a DRM service (e.g., DRM license requests) and/or a KMS 218 and/or a blockchain connector service 212, which may allow the marketplace service to interact with one or more ledger services (e.g., blockchain service 214) in connection with recording and/or verifying assertions consistent with various aspects of the disclosed embodiments. As detailed herein, the orchestrator service 210 may comprise a service used in connection with orchestrating and/or managing various services and/or operations performed by the marketplace service and/or constituent and/or related services (e.g., TRM services, which may be separate from and/or a part of the marketplace services). The service abstraction layer 208 may further interact with a marketplace service UaPS 216, which may post data with a content packaging service 202.

Although illustrated as being separate services, it will be appreciated that the marketplace service and the content distribution service (and indeed, a TRM service) and/or aspects thereof may be performed by a single service and/or any suitable combination of services.

The content packaging service 220 may package content for distribution via a content distribution network (“CDN”) 222. The CDN 222 may share a content catalog and/or available streaming media with users and/or artists via the content distribution service front end service 202. In some embodiments, keys may be received by the packaging service 220 from the DRM service and/or KMS 218 for use in connection with content packaging operations. The DRM service and/or KMS 218 may further provide DRM license(s) as appropriate to the content distribution service front end service 202 as part of the content distribution process.

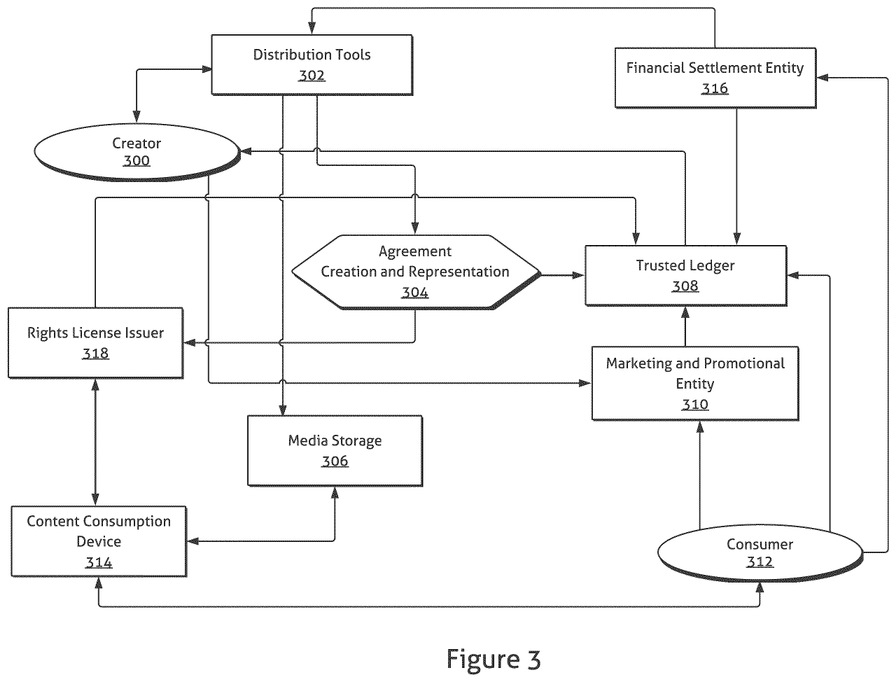

FIG. 3 illustrates non-limiting example of a content distribution and management process consistent with certain embodiments disclosed herein. As illustrated, a creator 300, which may also be referred to herein as an artist, who has a creative work may use a set of distribution tools 302, which in some embodiments may be offered by a content distribution service consistent with various disclosed embodiments, to encode, make legal agreements 304 defining the disposition of the media, bind the media and the identities and identifiers, create links to the content and the creators identities, distribute to the media storage 306 (e.g., distribute via a CDN, P2P, etc.), and/or write the locations and/or identities of some or all of the above to a trusted ledger 308, which may comprise a blockchain ledger.

The creator 300 may retrieve a link to and/or linked information which may include references to the media, agreements associated with that media, entities who may have participatory rights associated with that media (e.g., such as ownership, control, partial financial interest, etc.), the metadata associated with that media and other agreements from the trusted ledger 308 and post it to a marketing and promotional entity 310 such as a social network or a web site or an email marketing service. When a consumer 312 sees and/or follows the promotional link, it may take them to the distributed ledger 308 where they or their consumption device 314 may transact with the financial settlement entity 316 for payment. In some embodiments, they may also be redirected from the distributed ledger 308 to the media storage device 306 where they may acquire (e.g., download and/or stream) the media to their consumption device 314.

In various embodiments, media (or more generally, assets) may have certain associated information recorded in the trusted ledger 308 (e.g., information associated with fractional owners and/or owned token shares, metadata information such as title, links to encrypted content, and/or the like). Some information (e.g., revenue history) may be hashed and recorded in the trusted ledger 308. Data used to generate the recorded hashed values may be stored in another database. Embodiments disclosed herein may verify data stored in the database by checking its hashed value against hashes recorded in the trusted ledger 308.

The consumption device 314 may contact the rights license issuer 318 which may check with the distributed ledger 308 and, after confirmation, may issue a DRM license to the consumption device 314 which may render the content. The financial settlement entity 316 may distribute the remuneration to the creator 300 and/or to the entity associated with the distribution tools service 302 who may pass the remuneration to the artist and may take a fee depending on the contractual relationships among the parties.

### Artists and Distribution Tools

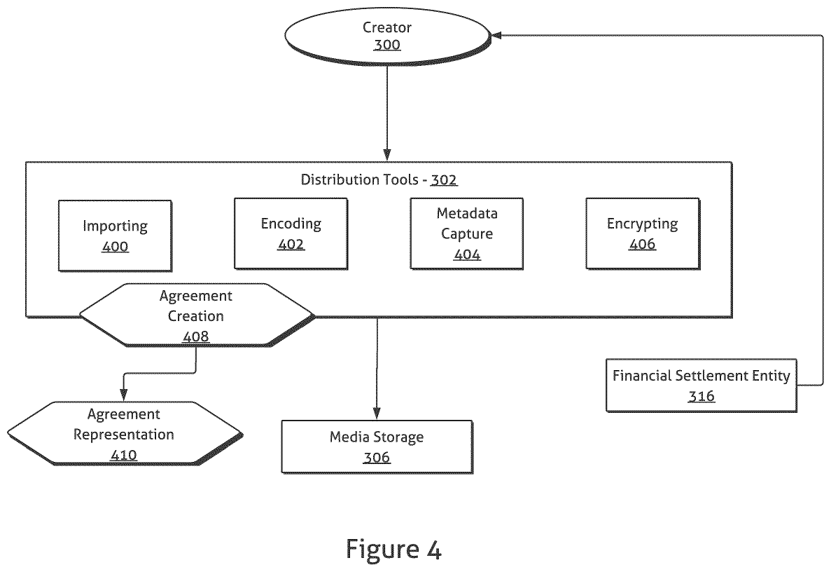

FIG. 4 illustrates a non-limiting example of a relationship between an artist, which in connection with the figure may be referred to as a creator 300, and various other entities consistent with certain embodiments disclosed herein. As shown, a creator 300 may use a set of distribution tools 302. These tools can be provided as a service online (e.g., a content distribution service consistent with various disclosed embodiments), a locally run software implementation, or a combination of parts of both. The creator 300 may have a digital representation of a creative work, which may be generally referred to herein as content. This could be a movie, a recording, a composition, a photograph, a journal article, a book, a 3D object, a scene represented by a point cloud, or any other form of media in digital form. In some embodiments, suitable tools may be used to digitize certain content (e.g., physical objects digitized via 3D scanning into a digital form) or take as input previously digitized media. Pre-encoded media can be imported via an import module 400 of the distribution tools 302. For input requiring encoding, encoding tools 402 may be used. These encoding tools could include, for example and without limitation, cameras, scanners, text parsers, artificial Intelligence prompts and/or any mechanism that might be used to create something in digital form. Encoding tools 402 may also include, for example and without limitation formatting, format conversion, and/or compression algorithms and might also include the embedding of steganographic information like watermarks.

In some embodiments, metadata capture 404 may be another tool offered by distribution tools 302. Metadata can be captured in any number of different ways including, but not limited to, filling in a website form, looking up credentials associated with an ID, facial or fingerprint recognition, analysis of the media using digital signal processing, and/or via any other suitable method. The metadata may include information about the content such as color palate, frame rate, sampling rate, bit depth, compression algorithms, etc., and/or information about the creators and/or rightsholders. Once the media has been captured and encoded and the metadata has been captured, the media may be encrypted using suitable encryption tools 406.

In certain embodiments, a special form of metadata may be used in connection with an agreement creation tool 408. In various embodiments, an agreement creation tool 408 may capture business parameters and/or conditions associated with the content, which may include but not be limited to: names of creators and co-creators (e.g., which may include their identities and/or identifying metadata like fingerprints, social security number, etc.), share of ownership (e.g. two songwriters each own half of the copyright), representatives of those rightsholders (e.g. music publisher, manager, agency, etc.), licensing terms (e.g. this can be sold as a non-fungible serialized object like #1 of 20, this can be part of a subscription service, this can be licenses in specific territories, this can be resold, this can be loaned or not for specific time periods or by limited numbers of people, ownership in the royalty stream can be shared fractionally), which can be as arbitrarily complex as can be represented electronically using any mechanism such as but not limited to DRM conditions.

Business conditions and/or parameters included in metadata may comprise public and/or private conditions. For example, a public business condition may allow a consumer to access (e.g., watch and/or listen to) a digital asset without engaging in an outright transaction (e.g., buy, rent, subscription). Public business conditions may comprise, for example and without limitation, sales, rental information, and/or associated price information.

A private business condition may allow, for example, a consumer to access (e.g., watch and/or listen to) a digital asset after having completed a purchasing transaction (e.g., buy, rent, subscribe). Private business conditions in this non-limiting example may comprise, for example, sellout and associated price information, rental and associated price information, and/or subscription and associated price information, and/or the like. It will be appreciated that a variety of business conditions may be associated with digital assets and/or products via metadata in connection with various embodiments disclosed herein.

Business conditions may express one or more granular conditions and/or permissions including, for example and without limitation, one or more of:
Do not allow for playback under certain conditions. For example and without limitation, playback for a digital asset and/or product may be restricted before a date and/or time and/or after a date and/or time (e.g., a playback period), within a certain country, location, and/or jurisdiction and/or combinations thereof.
Do not allow for rental/subscription to a digital asset and/or product under certain conditions. For example and without limitation, rental of and/or subscription to a digital asset and/or product may be restricted before a date and/or time and/or after a date and/or time (e.g., a rental period), within a certain country, location, and/or jurisdiction, for less than a minimum price, for more than a maximum price, and/or combinations thereof.
Do not allow for sale to a digital asset and/or product under certain conditions. For example and without limitation, sale of a digital asset and/or product may be restricted before a date and/or time and/or after a date and/or time (e.g., a sale period), within a certain country, location, and/or jurisdiction, for less than a minimum price, for more than a maximum price, and/or, based on the age or other characteristic of the purchaser including membership in a group or other entity or having the availability of a coupon or combinations thereof.
Do not allow for inviting a friend under certain conditions. For example and without limitation, invite permissions may be restricted before a date and/or time and/or after a data and/or time (e.g., an invite period), within a certain country, location, and/or jurisdiction, not to exceed a maximum quantity of invitations (e.g., simultaneous and/or total), and/or combinations thereof,
Limit the maximum quantity of rentals (e.g., simultaneous and/or total rentals).
Limiting the maximum number of sales allowed.

Business conditions expressed in metadata may further express an indication of fractional ownership and/or other rights held in connection with digital assets and/or associated products and/or NFTs. In certain embodiments, such fractional rights may be expressed in terms of ownership and/or rights holding shares, cuts, and/or percentages, although other methods and/or ways of implementing fractional ownership and/or rights holding are also envisioned. For example and without limitation, business conditions may express an indication of a name and/or other identity of rights holders and associated ownership rights and/or percentages of ownership rights for a digital asset, product, and/or associated NFT(s). In various embodiments, such fractional ownership and/or rights and/or rights may be traded and/or otherwise sold and/or exchanged using services enabled by embodiments of the disclosed ecosystem. Moreover, as discussed in more detail below, payment models and/or mechanisms between owners and/or rightsholders may be implemented based, at least in part, on fractional ownership and/or rights information detailed in business conditions.

The agreement may then be stored by an agreement representation module 410 which may store agreements for later representation and execution. In some embodiments, an agreement might be stored as some form of digital representation (e.g., a rights expression, a smart contract, etc.) and that representation may be stored in a database and/or on a trusted ledger. For security, the ledger may store the digital signature and a cryptographic hash of the agreement as well as the identities of the signatories. When an agreement is retrieved for execution, the right to retrieve and execute on that agreement can be governed and access granted to those with the correct permissions and credentials.

Once the agreement has been created by the agreement creation module 408 and represented by the agreement representation module 410, the encoded and or encrypted media can be uploaded to media storage 306. To complete the view from the creator's perspective, once the media has been consumed by consumers and renumeration has flowed to the various parties as prescribed in the agreement, a financial settlement entity 316 may (based on the agreement representation 410 pay the creator 300 and/or their representative

### Rights License Issuance

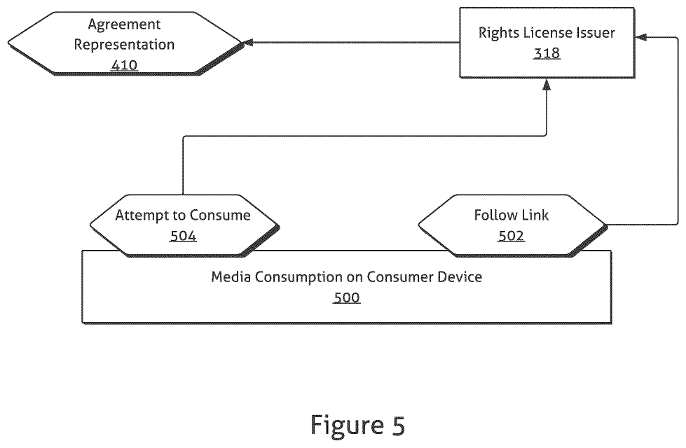

FIG. 5 illustrates a non-limiting example of a process associated with issuing rights licenses consistent with certain embodiments disclosed herein. In some embodiments, when a consumer wants to consume media 504, they may select the media in one of two ways. For example, they may follow a link in a document, web site, advertisement, etc. which points them back to a rights license issuer 318 and/or they have received the media from a third party and attempt to play it 504 and that playback request, needing a decryption key, sends them to the rights license issuer 318 The rights license issuer 318 may look up the agreement 410 providing the credentials of the entity wishing to consume the media. If those credentials, after parsing the agreement(s) determine that the consumer has the right to consume the media, the rights license issuer 318 may issue a license (or a decryption key) to the consuming device and the media can be consumed 500.

### Marketing, Promotion, and Superdistribution Tools

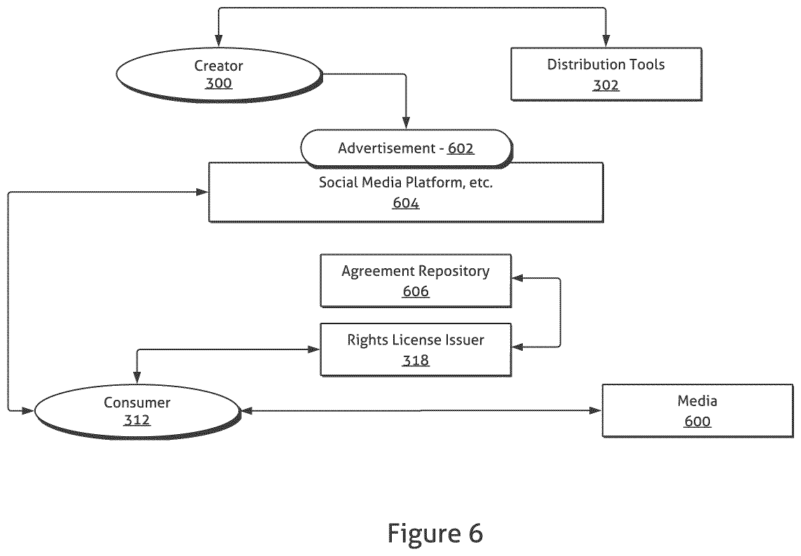

FIG. 6 illustrates a non-limiting example of tools used in marking, promotion, and superdistribution processes consistent with certain embodiments disclosed herein. If a creator 300 wants to distribute their media, using various aspects of the disclosed services, they may not necessarily need to use a traditional media distribution network like a streaming or download service. They can, in certain embodiments, simply create and distribute the media themselves using the tools described herein. Moreover, they can promote the media through direct advertising with a decentralized set of entities delivering the media and returning the remuneration.

In at least one non-limiting example shown in FIG. 6, after the creator 300 uses the distribution tools 302, they can receive a link which points back to the media and the associated agreements. They can place this link on or embed it in an advertisement 602 or field in a social media feed of a social media platform 604, an email, a web site, etc. When an interested customer 312 clicks on the link, they may be directed to the rights license issuer 318 which may check the agreement in the agreement repository 606 and, after determining the appropriate rules and executing on them digitally, may issue a license to the consumer 312 who can redeem the media 600 and render it on their device. It will be appreciated that the order can vary so that the consumer 312 could select the media first and then acquire the license or they could happen in parallel.

In addition to receiving a link from a web site, social media feed, email, etc., a consumer could receive a link from another consumer. This may be referred to in certain instances herein as superdistribution. If one consumer sends a link or the media itself to another entity (person, device, etc.). the receiving party can click on the link and a similar series of events may occur as above.

### Content Asset Creation, Purchase, and Playback Processes

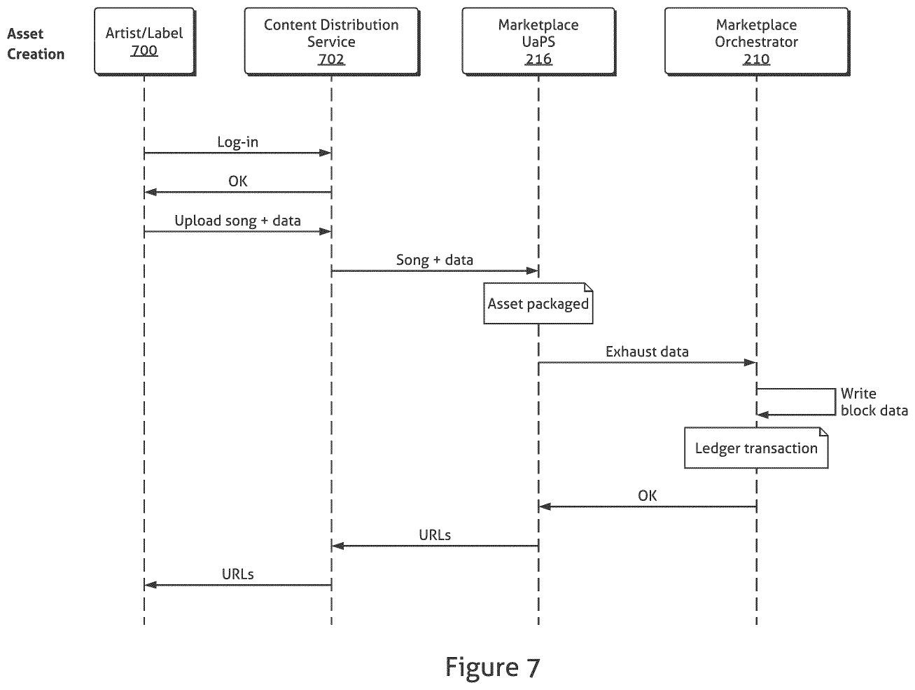

FIG. 7 illustrates a non-limiting example of an asset creation process consistent with certain embodiments disclosed herein. In various embodiments, an artist 700 (and/or a label associated with the artist 700) may log in and/or otherwise authenticate their access and/or identity with the content distribution service 702. For example, the artist 700 may share authentication credentials with the content distribution service 702 which may check the credentials to validate access. The content distribution service 702 may communicate an indication of successful authentication to the artist 700.

The artist 700 and/or associated label may upload an asset and/or associated data to the content distribution service 702. For example, as shown, the artist may upload a song, potentially along with associated metadata relating to the song, to the content distribution service 702. The content distribution service 702 may communicate the song and/or associated metadata to a UaPS 216 of the marketplace service for asset packaging. The UaPS 216 may further communicate information relating to the packaged asset (e.g., the packaged song) to an orchestrator service 210 of the marketplace service.

The marketplace orchestrator 210 may, potentially among other actions, interface with a ledger service (e.g., via a blockchain connector service of the marketplace service) to record information relating to the packaged asset, which may be written into a ledger block as part of a ledger transaction process. The orchestrator service 210 may receive a confirmation of successful entry of the record into the trusted ledger, which may share the confirmation with the UaPS 216. The UaPS 216 may share a link associated with the uploaded and packaged asset with the content distribution service 702 and/or the artist 700 that may be used to locate and/or otherwise access the packaged song. For example, in some embodiments, a URL link may be shared associated with the packaged song.

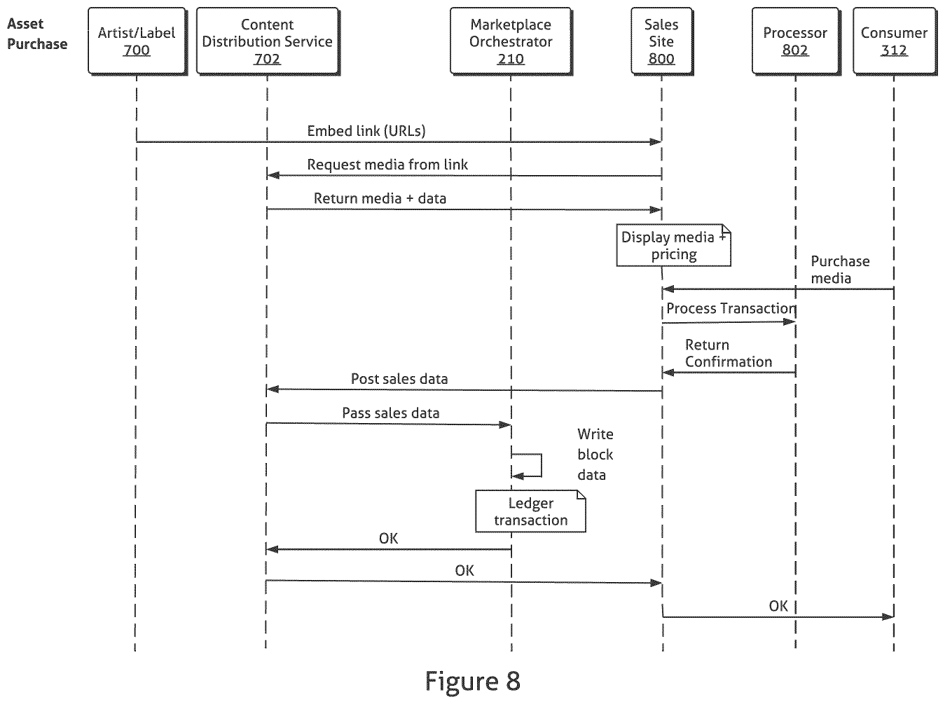

FIG. 8 illustrates a non-limiting example of an asset purchase process consistent with certain embodiments disclosed herein. As shown, the artist and/or label 700 may share and/or otherwise embed a link (e.g., a URL) to a song and/or other media with a sales site and/or portal 800, which in some embodiments may comprise a frontend sales portal of a content distribution service 702, a marketplace service, and/or some other media listing and/or distribution service. Media associated with the link may be requested by the sales site and/or portal 800 from the content distribution service 702, which may return the requested media and/or associated metadata to the sales site and/or portal 800.

A listing of media (e.g., song titles) and/or associated pricing information and/or other conditions, which may be determined based the received metadata, may be displayed by the sales site and/or portal 800 to various consumers 312. A consumer 312 may select a media title of interest and initiate a corresponding purchase transaction with the sales site and/or portal 800. In connection with the purchase, the sales site and/or portal 800 may interact with a payment processing service 802 to process the transaction. If the transaction process is successful, the payment processing service 802 may return a confirmation to the sales site and/or portal 800.

Upon receipt of the transaction confirmation, the sales site and/or portal 800 may post information indicating the sale with the content distribution service 702. The sale information may be passed to the orchestrator service 210 of the marketplace service by the content distribution service 702. The marketplace orchestrator 210 may, potentially among other actions, interface with a ledger service (e.g., via a blockchain connector service of the marketplace service) to record information relating to the sale, which may be written into a ledger block as part of a ledger transaction process. Upon successfully entering the information into the ledger, the marketplace orchestrator 210 may return a confirmation to the content distribution service 702, which may be shared with the sales site and/or portal 800 and/or the consumer 312.

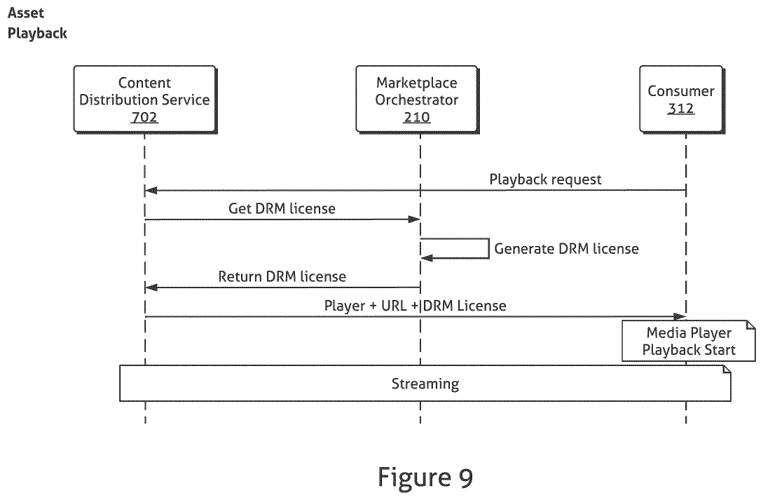

FIG. 9 illustrates a non-limiting example of an asset playback process consistent with certain embodiments disclosed herein. A consumer 312 (via an associated system and/or device) may request playback of an asset (e.g., a song) from the content distribution service 702. In response to receiving the request, the content distribution service 702 may issue a request to the marketplace service (and/or a constituent DRM services and/or a KMS) for a DRM license. If the requested playback is authorized (e.g., as indicated by IAM services of the marketplace service), a DRM license may be generated by the marketplace service(s) and the orchestrator service 210 may return to generated DRM license to the content distribution service 702.

The content distribution service may provide the consumer 312 and/or their associated system and/or device with a link to the asset and/or song (e.g., a URL) and the DRM license received from the marketplace service. In some embodiments, the player application for use by the consumer 312 and/or their associated system and/or device to playback the asset may also be distributed and/or linked to. Using their associated system and/or device, the consumer 312 may start playback of the asset. In the illustrated example, the asset may be streamed from the content distribution service and/or an associated service to the consumer 312.

Fractional Token Rights, Revenue, and/or Investor Management

Consistent with various disclosed embodiments, digital assets and/or associated products and/or NFTs may be associated with fractional ownership and/or other rights (e.g., revenue rights, which may be fractional as well). In some embodiments, such rights may be expressed in business conditions expressed in metadata. In certain embodiments, fractional rights may be expressed in terms of ownership and/or rights holding shares, cuts, and/or percentages, although other methods and/or ways of implementing fractional ownership and/or rights holding are also envisioned. In various embodiments, fractional ownership and/or rights and/or rights may be traded and/or otherwise sold and/or exchanged using services enabled by embodiments of the disclosed ecosystem. Moreover, as discussed in more detail below, payment models and/or mechanisms between consumers, owners, rightsholders, and/or investors (which may hold certain fractional rights) may be implemented based, at least in part, on fractional ownership and/or rights information detailed in business conditions.

As detailed above, NFTs may be associated with song and/or other electronic content assets. It will be appreciated, however, that although other types of content and/or assets may be also managed using various disclosed embodiments. Non-limiting examples of various processes involving a token associated with a song asset are detailed below, including methods reflecting fractional ownership, revenue, and/or other investor rights management processes. Such processes may include, for example and without limitation, token creation, ownership transfer, revenue management, asset update, revenue update, asset retrieval, transaction history retrieval, and/or playback processes.

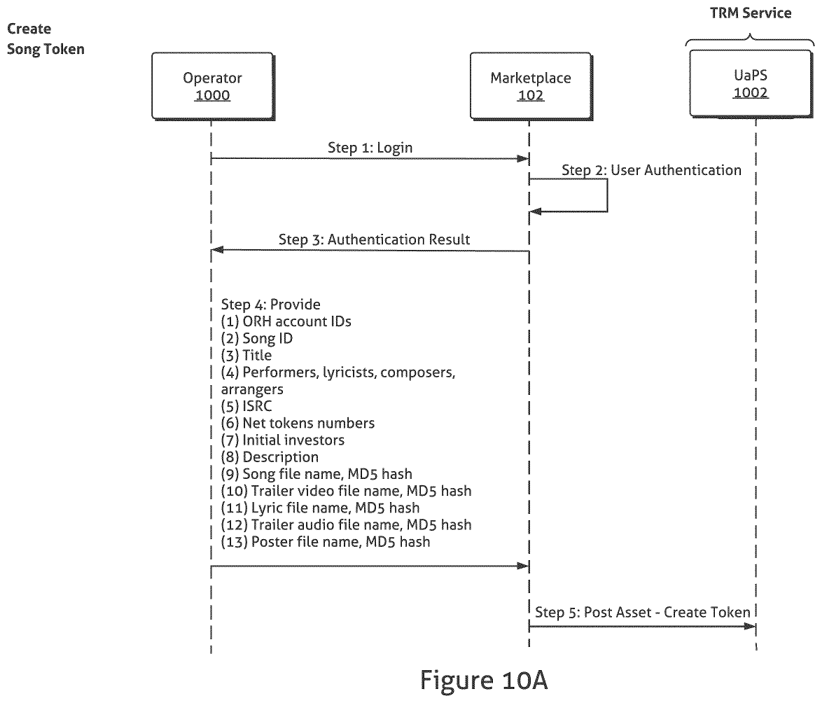

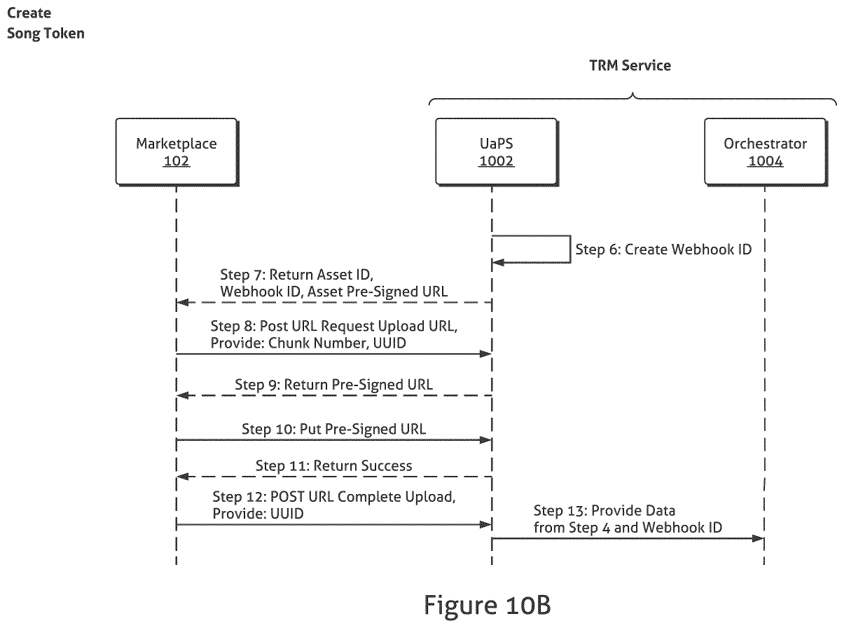

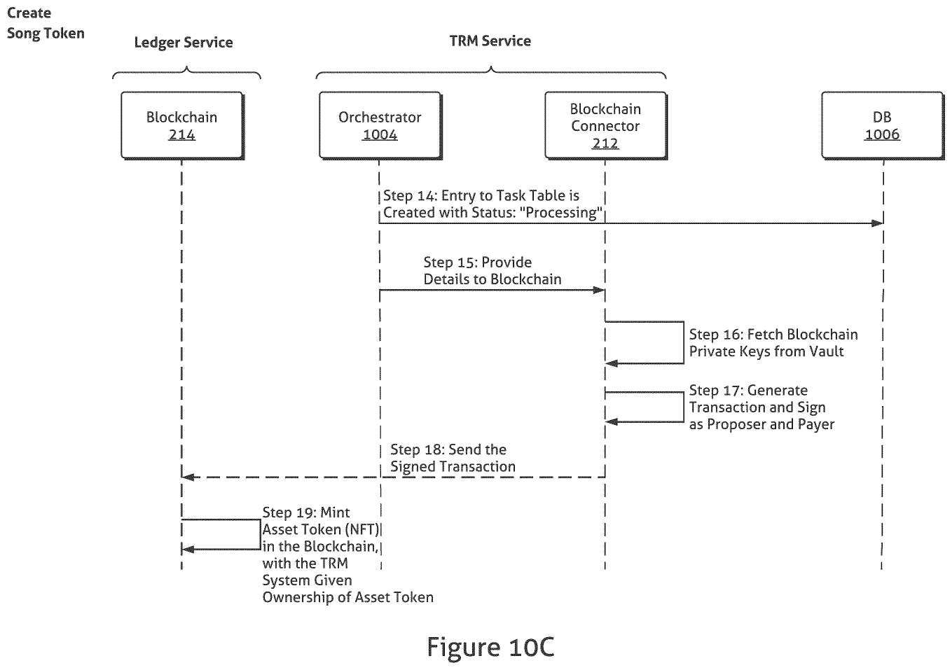

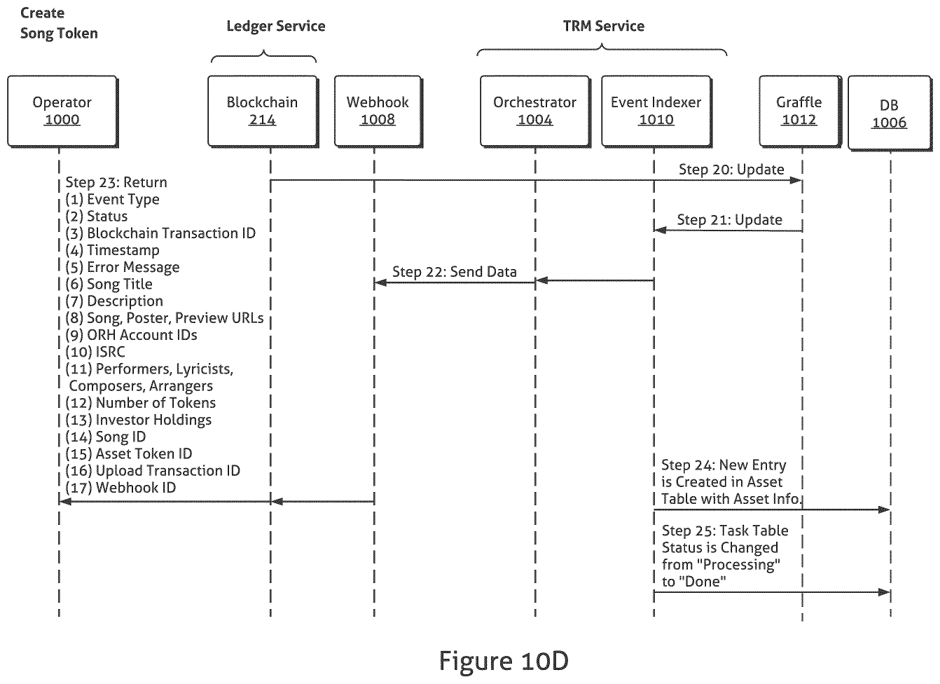

FIGS. 10A-10D illustrate a non-limiting example of a song token creation process consistent with certain embodiments disclosed herein. As illustrated, an operator 1000 may interact with a marketplace service 102 in connection with various asset management processes detailed herein. For purposes of simplification, the general term “operator” is used in certain figures and examples herein, but it will be appreciated that depending on the context and/or use case, an operator 1000 may comprise an artist, creator, rightsholder, investor, consumer, and/or the any other entity and/or an associated system and/or device that may interact with various systems and/or services of the disclosed embodiments.

The operator 1000 may log in to the marketplace service 102 using associated authentication credentials. For example, the operator 1000 may provide a front-end service of the marketplace service 102 with a username and a password for authentication purposes. The marketplace 102 may authenticate the operator 1000 based on the provided credentials and communicate an authentication result to the operator and/or their associated system and/or device 1000. In some embodiments, other suitable authentication methods may also be used that, in some embodiments, may leverage one or more authentication services (e.g., single sign on (“SSO”) authentication methods and/or the like). In some embodiments, an IAM service of the marketplace service 102 may be used in connection with authentication.

Upon successfully authenticating with the marketplace service 102, the operator 1000 may provide the marketplace service 102 with various information relating to a digital asset—a song in the illustrated non-limiting examples—that it would like to have associated with a new token. This information may, in some embodiments, comprise various ID information relating to the song, which may include rightsholder information, and/or metadata associated with the song. For example and without limitation, the operator 1000 may provide the marketplace service 102 with one or more of a rightsholder account ID with the marketplace service 102 (e.g., an ORH account ID), an ID associated with the song, a title of the song, metadata associated with performers, lyricists, composers, arrangers, and/or other creators associated with the song, an International Standard Recording Code (“IRSC”) ID and/or other universal identifier associated with the song, information relating to net token numbers (e.g., the number of tokens to be generated associated with the song), information relating to initial investors associated with the song, a description of the song, a song file name and/or an associated hash of the song file, a trailer video file name and/or an associated hash of the trailer video file, a lyric file name and/or an associated hash of the lyric file, a trailer audio file name and/or an associated hash of the trailer audio file, a poster and/or other promotional content file name and/or an associated hash of the poster and/or other promotional content. As detailed above, in various information, certain information communicated by the operator 1000 to the marketplace service 102 in connection with a token creation request may be expressed in metadata associated with the song.

Various IDs are detailed herein in connection with the disclosed embodiments including, for example and without limitation, account IDs, IDs associated with assets (e.g., song IDs), certain structured and/or otherwise standardized IDs (e.g., IRSRC IDs), and/or the like. It will be appreciated that, in some implementations, certain IDs used herein may be anonymous in nature and/or otherwise be anonymized. That is, certain IDs may not necessarily directly identify a entity and/or account holder. In some embodiments, anonymized IDs may be correlated with actual IDs using secure identity management systems and/or associated services.

Information relating to initial investor holdings in a song may take several forms. Consistent with certain embodiments disclosed herein, investor holdings information may reflect fractional interests in the asset. For example and without limitation, if a first investor holds 70% of the interest in an asset and a second investor holds 30% interest, fractional investor interest information may be reflected as follows:

“investor holdings”: {
“investor_id_1”: 70,
“investor_id_2”: 30
},

In certain embodiments, fractional ownership may be managed based on a number of shares and/or tokens owned by a particular entity (e.g., an investor) relative to a total number of shares and/or tokens minted for a particular asset. For example, when an asset is created, a net number of tokens minted for an asset may be specified. Ownership of the asset may thus be expressed and/or otherwise managed based on trading associated asset tokens. For example, in the above example, if 100 tokens are minted for a particular asset, an investor holding 70% interest in the asset may own 70 tokens for the asset, and an investor holding 30% interest in the asset may own 30 tokens for the asset. It will be appreciated, however, that fractional interests may be managed in a number of other ways, including in asset management paradigms where a single token is minted for a particular asset with interest in the asset being managed via metadata and/or other suitable frameworks expressing ownership as a fractional percentage of ownership in the single token and/or asset.

The marketplace service 102 may communicate a request to create a token to a packaging service 1002, which in some embodiments may be associated with a TRM service (and/or may be service of the marketplace service and/or another media service). In some embodiments, the request may comprise information relating to the song asset received from the operator 1000 (e.g., some and/or all of the information received in the illustrated Step 4). The packaging service 1002 may, in response to the request, create a webhook ID associated with the request. As detailed here, a webhook may comprise a callback function that allows relatively lightweight, event-driven communication between a plurality of application programming interfaces (“APIs”).

The marketplace service 102 and the packaging service 1002 may engage in a series of interactions in connection with uploading an asset for tokenization. For example, the packaging service 1002 may return an indication of an assigned asset ID, the webhook ID, and/or a pre-signed link (e.g., a URL) associated with the song to the marketplace service 102. The marketplace service 102 may post to the packaging service 1002 a link request, providing an upload link, a chunk number, and/or a Universally Unique Identifier (“UUID”). The packaging service 1002 may return a pre-signed URL to the marketplace service 102, which may be used by the marketplace service 1002 to post to the packaging service 1002 a link for the complete upload and/or the UUID. The packaging service 1002 may then provide the data relating to the song asset received from the operator 1000 (i.e., some and/or all of the information received in the illustrated Step 4) and/or the webhook ID to an orchestrator service 1004 of the TRM service.

A variety of tables may be used in connection with managing tokens in connection with various disclosed embodiments. In some embodiments, the tables may be managed by a DB service 1006. Although illustrated as a separate service, it will be appreciated that the DB service 1006 may be included in the TRM service and/or a marketplace service. These tables may comprise, for example and without limitation, one or more of:
Task table—A task table may comprise, for example and without limitation, one or more of a task ID, marketplace ID, creator ID, asset ID/product ID (potentially used for update), title, task timestamp, asset/product, status (e.g., processing, done, failed, deleted, etc.), a type of task (e.g., upload, update, delist, delete), etc.
Asset table—An asset table may comprise, for example and without limitation, one or more of an asset ID (which may be unique for each asset), marketplace ID, media type (e.g., audio, video, image, text, etc.), encrypted content key, key identifier (“KID”), file location URL, title, asset assertion, fact (e.g., a hash of a file content), upload timestamp, ORH ID, metadata, initial supply, remaining supply, preview URL, etc.
Product table—A product table may comprise, for example and without limitation, one or more of a product ID, product serial ID, marketplace ID, name, assets (e.g., list of asset IDs included in bundle), serial number, type (e.g., public or private), preview URL, listed timestamp, owner ID, ORH ID, business-condition (e.g., an array of business conditions), sell price, rent price, rental period, metadata (e.g., JSON), product assertion, fact, delist, delete, invitees (e.g., list of invitee IDs), etc.
Transaction table—A transaction table may comprise, for example and without limitation, one or more of a transaction ID, marketplace ID, owner ID, consumer ID, product serial ID, timestamp, business condition, sell-price, rent-price, rental expiry date, asset ID, etc.
Marketplace user table—A marketplace user table may comprise, for example and without limitation, one or more of a user ID, e-mail, name, account creation timestamp, balance, role (e.g., a role supported by marketplace services 102), etc.
Marketplace table—A marketplace table may comprise, for example and without limitation, one or more of a marketplace ID, name, contact e-mail, and/or the like. This table may be managed manually by a TRM administrator. When a new marketplace service 102 is provisioned, its account may be created and an entry in this table may be created with marketplace ID set to the newly created account ID.
Revenue table—A revenue table may comprise, for example and without limitation, any information relating to revenue transactions.
Investor table—An investor table may comprise, for example and without limitation, any information relating to investors in assets (e.g., assets included in the asset table).

As shown in FIG. 10C, the orchestrator 1004 of the TRM service may communicate with the DB service 1006 to create an entry into a task table associated with creation of the song token with an associated status set to “processing.” The orchestrator 1004 may further provide details relating to the song token being created (which in some embodiments may include some or all the details provided by the operator 1000 in the illustrated Step 4) to a blockchain connector service 212 of the TRM service.

For example and without limitation, with respect to investor information, in some embodiments, the orchestrator service 1004 may calculate investor hash information as a function of a transferer/transferee IDs and associated token information as follows:
investor_hash=SHA256 [transfer_ownership=from_investor_id, to_investor_id, number of tokens].

In some embodiments, transfer_ownership may be set to null if a token transfer is not created during the creation of a song token. In some embodiments, the orchestrator 1004 may send investor_hash to the blockchain connector service 212 for recordation in the blockchain 214. As detailed below, the blockchain connector service 212 may further include the investor_hash as part of a signed transaction to record it as an asset token with the blockchain 214.

The blockchain connector service 212 may retrieve a private key(s) from a key vault and/or other secure repository and generate and sign a transaction assertion using the private key(s). The signed transaction may be sent, by the blockchain connector service 212 to a ledger service for recordation in a blockchain 214 and/or other trusted ledger. The ledger service may mint an asset token (e.g., an NFT) in the blockchain 214 with the TRM service listed as being the initial owner of the asset token.

After minting the token, the blockchain 214 may update a layer used to query, write, and/or read from the blockchain 214 (e.g., a Graffle service 1012 and/or the like). The update may be shared with an event indexer service 1010 of the TRM service, which may share the update and/or associated data with the orchestrator service 1004 and/or a webhook service 1008. Based on receiving the update, the webhook service 1008, which may facilitate event-drive communication between the orchestrator service 1004 and/or the marketplace service 102, may direct the marketplace service 102 to return information relating to the minting of the token to the operator 1000.

For example, as shown, the marketplace service 102 may return one or more of an indication of an event type (e.g., token minting), an associated status (e.g., token minted), a blockchain transaction ID, a timestamp, any error messages, song information which may comprise the song title and/or description, song, poster, or preview links (e.g., URLs), ID information regarding the ORH and/or other rightsholders, ISRC IDs, metadata indicating performers, lyricists, composers, and/or arrangers of the song, a number of minted tokens, an indication of investor holdings, other IDs, which may comprise one or more of a song ID, a corresponding asset token ID, a upload transaction ID, and/or a webhook ID, and/or any other information relating to the minting of the token.

The event indexer service 1010 of the TRM service may update one or more tables to reflect the token minting transaction. For example, a new entry may be created in an asset table managed by the DB service 1006 with the new asset information. In addition, the task table status for transaction may be changed from “processing” to “complete” and/or the like to reflect that the token minting transaction has been successful completed.

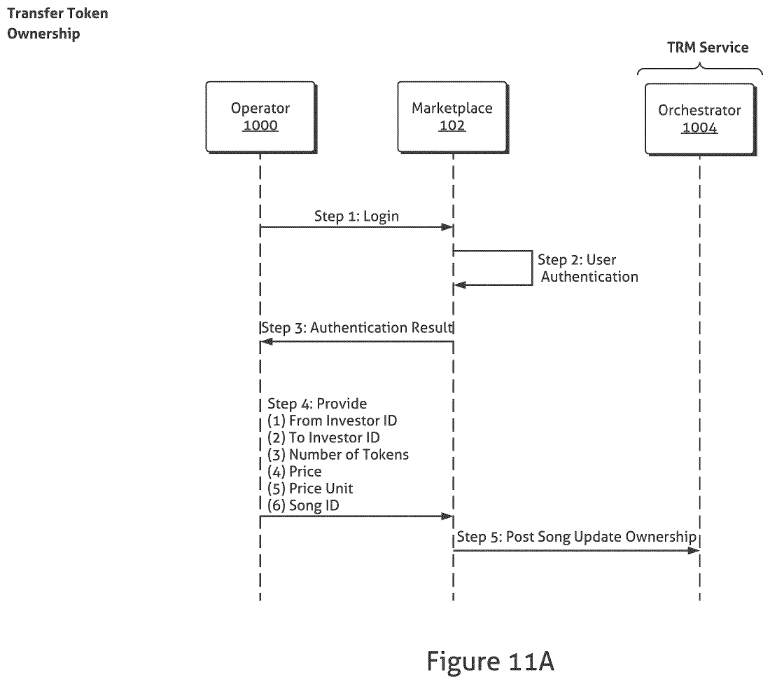

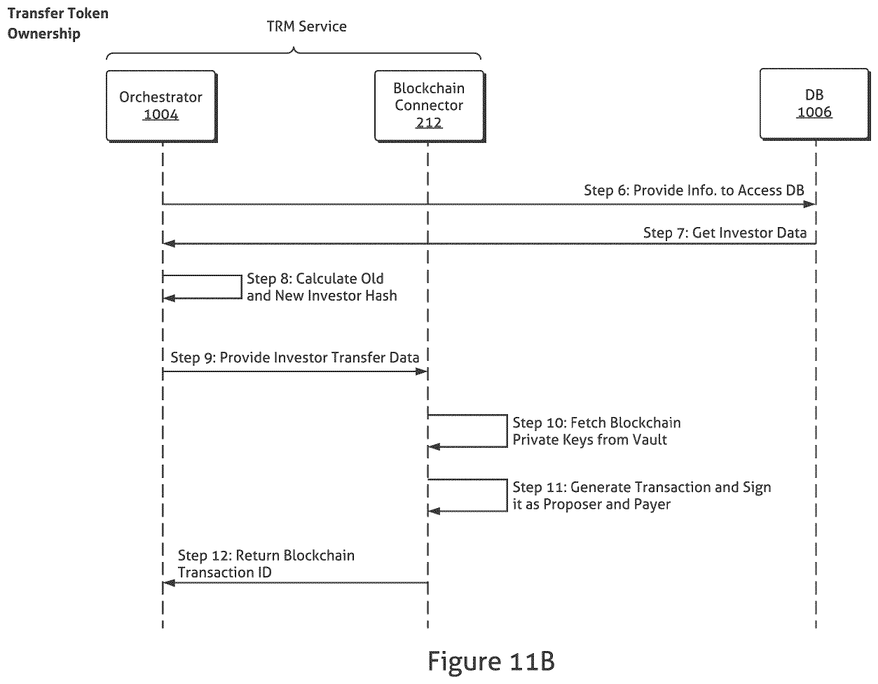

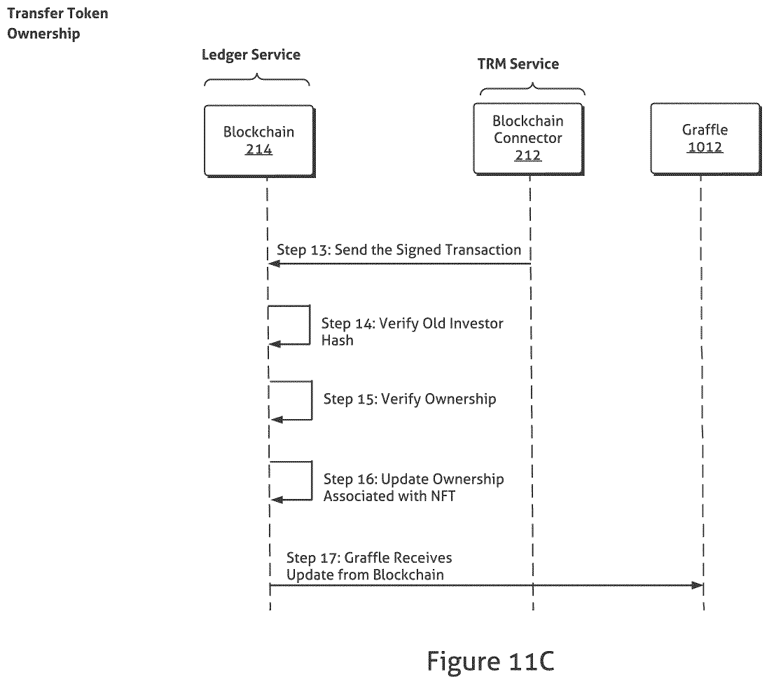

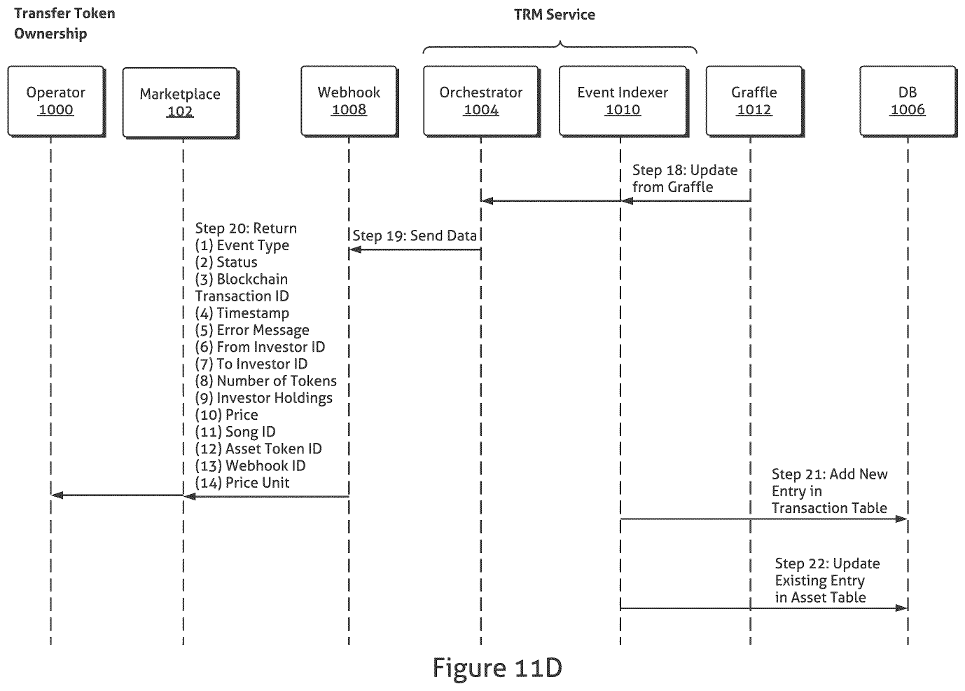

FIGS. 11A-11D illustrate a non-limiting example of a token ownership transfer process consistent with certain embodiments disclosed herein. In the illustrated process, the operator 1000 may log in to the marketplace service 102 using associated authentication credentials. The marketplace service 102 may authenticate the operator 1000 based on the provided credentials and communicate an authentication result to the operator and/or their associated system and/or device 1000.

Upon successfully authenticating with the marketplace service 102, the operator 1000 may provide the marketplace service 102 with various information relating to the transfer of ownership digital asset and/or an associated token. This information may, in some embodiments, comprise various ID information relating to the asset, which may include various information relating to the transfer of ownership between investor parties. For example and without limitation, the operator 1000 may provide the marketplace service 102 with one or more of a transferor investor ID (e.g., a “from” investor ID), a transferee investor ID (e.g., a “to” investor ID), a number of tokens being transferred (e.g., if an asset is associated with 100 minted tokens, and 70% ownership interest is being transferred, then the total number of tokens being transferred may be 70), a price associated with the transfer, a unit price, and an ID of the associated song.

The marketplace service 102 may communicate a request to update ownership of a token to an orchestrator service 1004 of a TRM service. The orchestrator service 1004 may provide information to access and/or retrieve investor data information to the DB service 1006 (e.g., access credentials and/or investor data retrieval information). The DB service 1006 may provide the orchestrator service 1004 with the requested investor information. For example, the orchestrator service 1004 may retrieve any previous transfer_ownership(s), investor_holdings, and their transaction_timestamp(s) from the DB service 1006. In some implementations, due to computation resources and performance limitations, the orchestrator service 1004 may get recent n numbers of investor_holdings.

Based on the received information, the orchestrator service 1004 may calculate an old investor hash and a new investor hash. In certain embodiments, the investor hashes may be generated based on investor holdings that, as detailed above, may be expressed as a number of tokens owned by an investor associated with a particular asset. For example and without limitation, in some embodiments, the orchestrator service 1004 may calculate:
current_investor_hash=SHA256 [[transfer_ownership_0, investor_holdings_0, transaction_timestamp_0], [transfer_ownership_1, investor_holdings_1, transaction_timestamp_1], [transfer_ownership_2, investor_holdings_2, transaction_timestamp_2], . . . [transfer_ownership_9, investor_holdings_9, transaction_timestamp_9]].
new_investor_hash=SHA256 [[transfer_ownership_0, investor_holdings_0, transaction_timestamp_0], [transfer_ownership_1, investor_holdings_1, transaction_timestamp_1], [transfer_ownership_2, investor_holdings_2, transaction_timestamp_2], . . . [transfer_ownership_9, investor_holdings_9, transaction_timestamp_9], [transfer_ownership_10, investor_holdings_10, transaction_timestamp_10]]

The investor transfer data may be provided by the orchestrator service 1004 to the blockchain connector service 212. The blockchain connector service 212 may retrieve a private key(s) from a key vault and/or other secure repository and generate and sign a transaction assertion using the private key(s). The signed transaction may be sent, by the blockchain connector service 212 to a ledger service for recordation in a blockchain 214 and/or other trusted ledger. For example, the orchestrator service 1004 may send the current_investor_hash and new_investor_hash to the blockchain connector service 212.

The ledger service may verify the old investor hash and ownership of the asset. For example, the blockchain connector service 212 may coordinate with the blockchain 214 to verify the current_investor_hash against the corresponding song token. If verified, the ledger service may update the ownership information associated with the NFT to reflect the transfer of ownership to the new investor. After updating the ownership information, the blockchain 214 may update the Graffle service 1012. The update may be shared with an event indexer service 1010 of the TRM service, which may share the update and/or associated data with the orchestrator service 1004 and/or a webhook service 1008. Based on receiving the update, the webhook service 1008 may direct the marketplace service 102 to return information relating to the minting of the token to the operator 1000.

For example, as shown, the marketplace service 102 may return one or more of an indication of an event type (e.g., token minting), an associated status (e.g., token minted), a blockchain transaction ID, a timestamp, any error messages, transferor investor ID information, transferee investor ID information, a number of associated tokens, an indication of investor holdings, asset price and/or unit price, other IDs, which may comprise one or more of a song ID, a corresponding asset token ID, and/or a webhook ID, and/or any other information relating to the transfer of ownership of the of the token.

The event indexer service 1010 of the TRM service may update one or more tables to reflect the ownership update transaction. For example, a new entry may be created in a transaction table managed by the DB service 1006 with the updated ownership transaction. In addition, an existing entry associated with the token may be updated to reflect the changed ownership in the asset table.

In case of multiple simultaneous update_ownership transactions for a certain song token, the blockchain connector service 212 may compare the current_investor_hash with ongoing transactions new_investor_hash to avoid miscalculations. As an example, consider a transaction 1 with current_investor_hash_1 and new_investor_hash_1 for the song_id_1. Before transaction 1 gets completed, transaction 2 comes with current_investor_hash_2 and new_investor_hash_2 for the song_id_1. In this case, the blockchain connector service 212 may compare current_investor_hash_2 with the new_investor_hash_1. If these two values match, the transaction 1 is already successfully completed, so the blockchain connector may proceed to the transaction 2. If these two values do not match, the transaction 1 is not completed yet, so blockchain connector service 212 may stop processing the transaction 2 and return the error so that multiple simultaneous transactions do not create inconsistent records between the DB service 1006 and the blockchain 214.

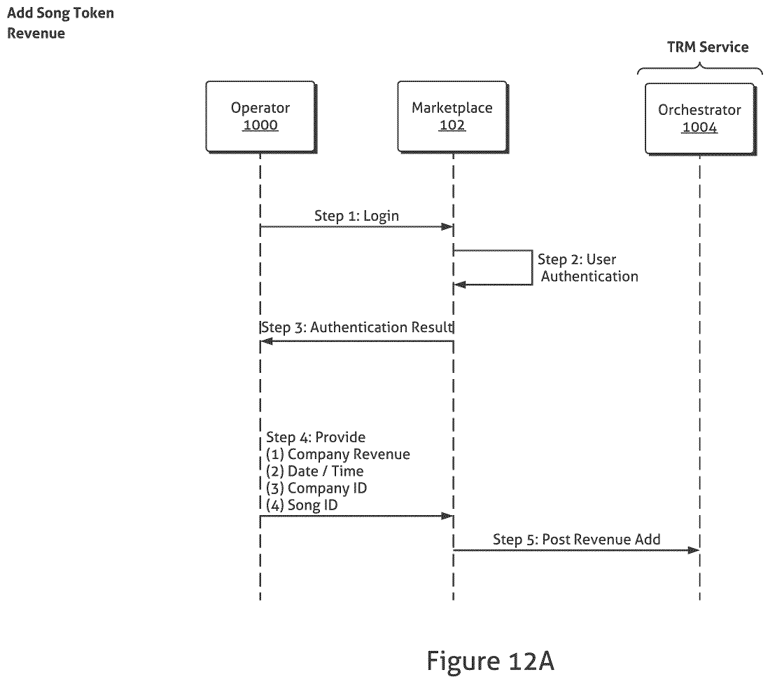

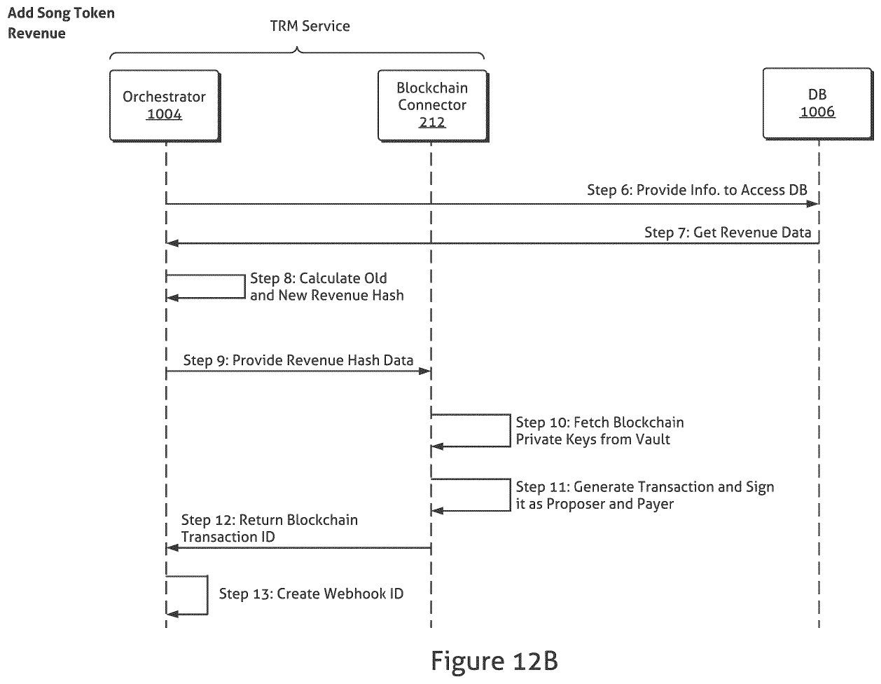

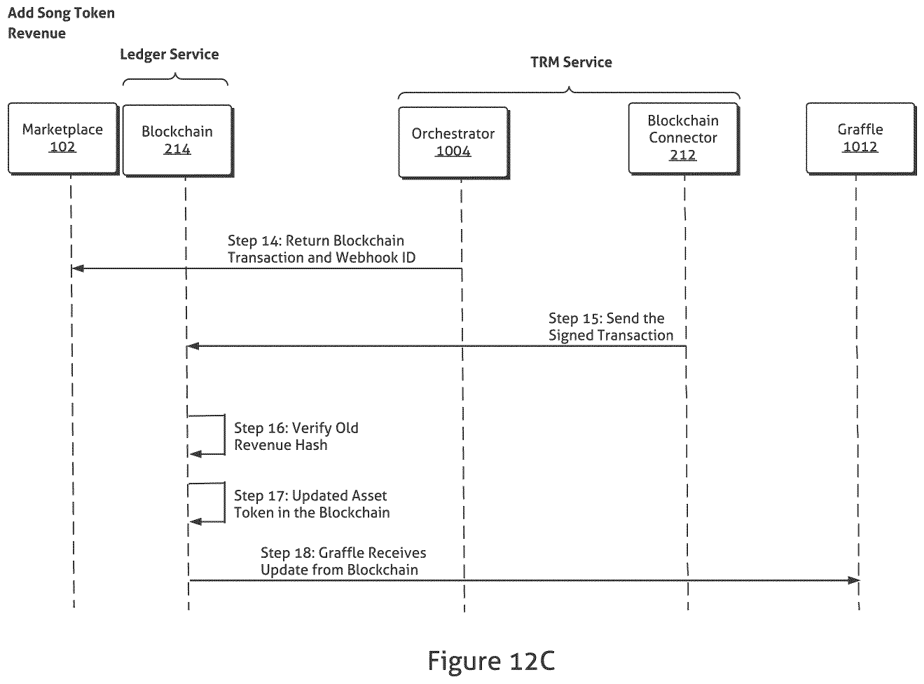

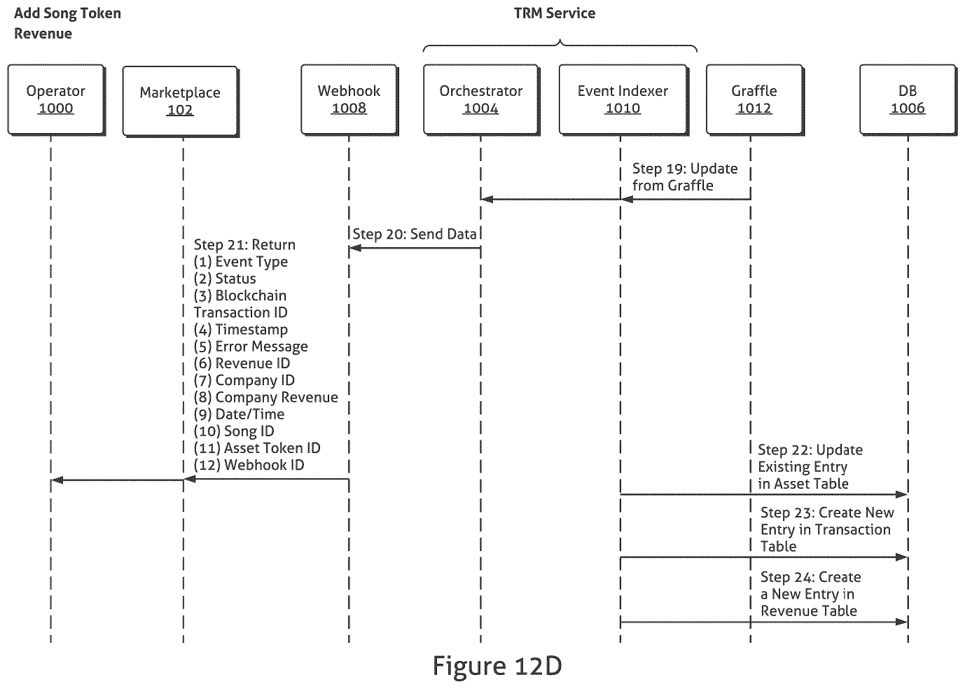

FIGS. 12A-12D illustrate a non-limiting example of a song token revenue management process consistent with certain embodiments disclosed herein. As shown, the operator 1000 may log in to the marketplace service 102 using associated authentication credentials. The marketplace service 102 may authenticate the operator 1000 based on the provided credentials and communicate an authentication result to the operator and/or their associated system and/or device 1000.

Upon successfully authenticating with the marketplace service 102, the operator 1000 may provide the marketplace service 102 with various information relating to adding generated revenue associated with a particular token. This information may, in some embodiments, comprise one or more of revenue information, date and/or time information (e.g., timestamp information relating to the revenue add transaction and/or individual revenue transaction subject to the revenue add transactions), an indication of a company ID adding the revenue, and an ID of the associated song.

The marketplace service 102 may communicate a request to add song token revenue to an orchestrator service 1004 of a TRM service. For example and without limitation, the orchestrator service 1004 may receive from the marketplace service 102 and indication of new revenue (e.g., company_id_10, datetime_10, company_revenue_10) for a certain song_token (e.g., identified with a song_id). The orchestrator service 1004 may provide information to access and/or retrieve revenue data information to the DB service 1006 (e.g., access credentials and/or investor data retrieval information). The DB service 1006 may provide the orchestrator service 1004 with the requested revenue information. For example, the orchestrator service 1004 may receive the previous revenue for the identified song token. For a newly created song token, there may not be revenue data stored in the DB service 1006. In certain embodiments, due to computation resources and/or performance limitations, only a recent n number of revenue entries may be retrieved.

Based on the received information, the orchestrator service 1004 may calculate an old revenue hash and a new revenue hash. If no previous revenue information was stored by the DB service 1006 for the song token, generation of old and/or current revenue hash may be skipped. For example and without limitation, in some embodiments, the orchestrator service 1004 may calculate:
current_revenue_hash=SHA256[[song_id, company_id_1, datetime_1, company_revenue_1], [song_id, company_id_2, datetime_2, company_revenue_3], . . . [song_id, company_id_9, datetime_9, company_revenue_9]]
   In certain embodiments, this step may be skipped if there are no previous revenue information in the DB service for the song token.
new_revenue_hash=SHA256[[song_id, company_id_1, datetime_1, company_revenue_1], [song_id, company_id_2, datetime_2, company_revenue_3], . . . [song_id, company_id_9, datetime_9, company_revenue_9], [song_id, company_id_10, datetime_10, company_revenue_10]]

The revenue hash data may be provided by the orchestrator service 1004 to the blockchain connector service 212. The blockchain connector service 212 may retrieve a private key(s) from a key vault and/or other secure repository and generate and sign a transaction assertion using the private key(s). An ID of the signed transaction may be sent, by the blockchain connector service 212 to the orchestrator service 1004. The orchestrator service 1004 may generate webhook ID associated with the transaction. In some embodiments, the blockchain connector service 212 may include the new_revenue_hash as a part of the signed transaction to record it at the asset token at the illustrated Step 12. In case of multiple simultaneous add song token revenue transactions for a certain song token, the blockchain connector service 212 may compare the current_revenue_hash with ongoing transactions new_revenue_hash to avoid miscalculations.

For example, consider a transaction 1 with current_revenue_hash_1 and new_revenue_hash_1 for the song_id_1. Transaction 2 may be received with current_revenue_hash_2 and new_revenue_hash_2 for the song_id_1 before transaction 1 gets completed. In this case, the blockchain connector service 212 may compare current_revenue_hash_2. If these two values match, the transaction 1 may already be successfully completed, so the blockchain connector service 212 may proceed to transaction 2. If these two values do not match, the transaction 1 may not be completed yet, so the blockchain connector service 212 may stop processing the transaction 2 and return the error so that multiple simultaneous transactions do not create inconsistent records between the DB service 1006 and the blockchain 214.

The orchestrator service 1004 may return the blockchain transaction and/or webhook ID to the marketplace service 1002. The signed transaction may be sent by the blockchain connector service 1004 to the blockchain 214 of the ledger service for recordation. The ledger service may verify the old revenue hash. For example, the blockchain connector service 212 may coordinate with the blockchain 214 to verify the current_revenue_hash against the corresponding song token. If verified, the ledger service may update the asset token to reflect the new revenue. After updating the revenue information, the blockchain 214 may update the Graffle service 1012. The update may be shared with an event indexer service 1010 of the TRM service, which may share the update and/or associated data with the orchestrator service 1004 and/or a webhook service 1008. Based on receiving the update, the webhook service 1008 may direct the marketplace service 102 to return information relating to the minting of the token to the operator 1000.

For example, as shown, the marketplace service 102 may return one or more of an indication of an event type (e.g., revenue add), an associated status (e.g., revenue added), a blockchain transaction ID, a timestamp, any error messages, revenue ID, company ID, company revenue information, dates and/or times associated with the added revenue, other IDs, which may comprise one or more of a song ID, a corresponding asset token ID, and/or a webhook ID, and/or any other information relating to the transfer of ownership of the of the token.

The event indexer service 1010 of the TRM service may update one or more tables to reflect the revenue add transaction. For example, an existing revenue entry in the asset table managed by the DB service 1006 may be updated, a new entry may be created in the transaction table managed by the DB service 1006, and a new entry may be created in a revenue table managed by the DB service 1006 to reflect the added revenue.

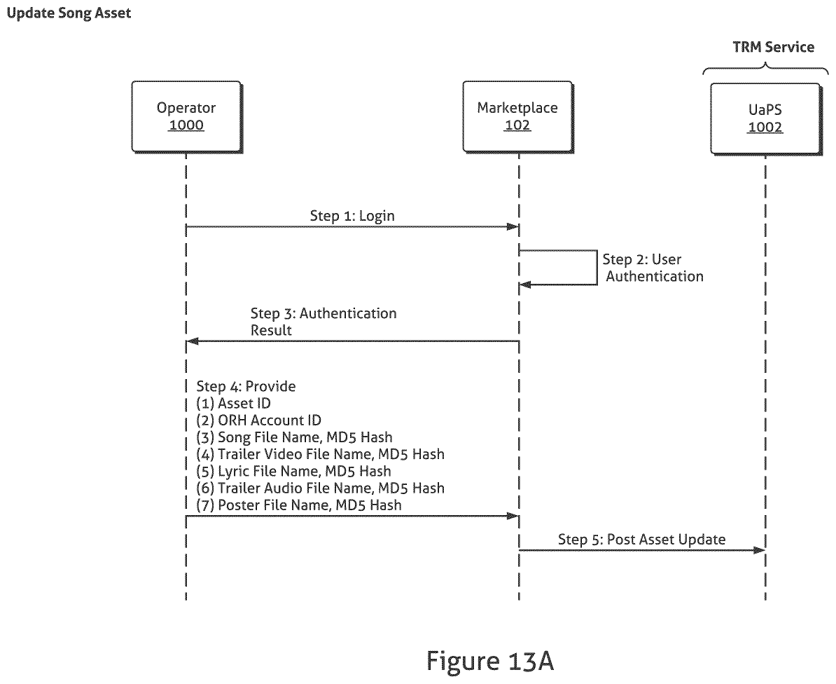

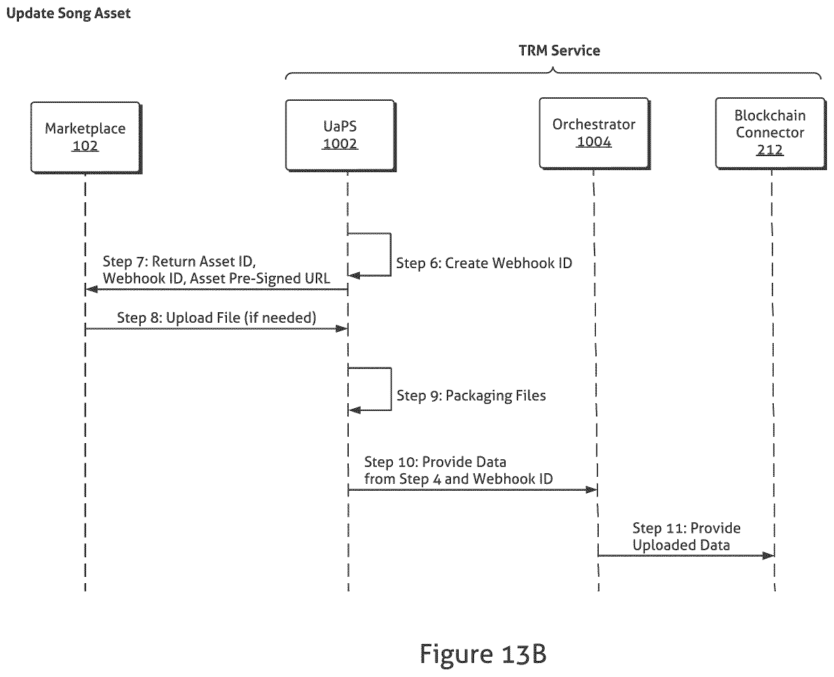

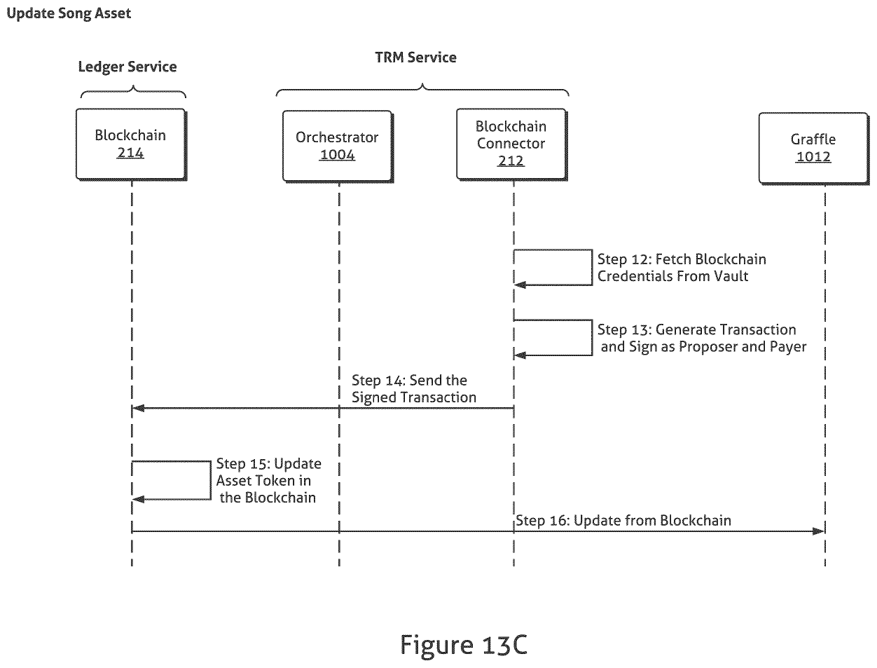

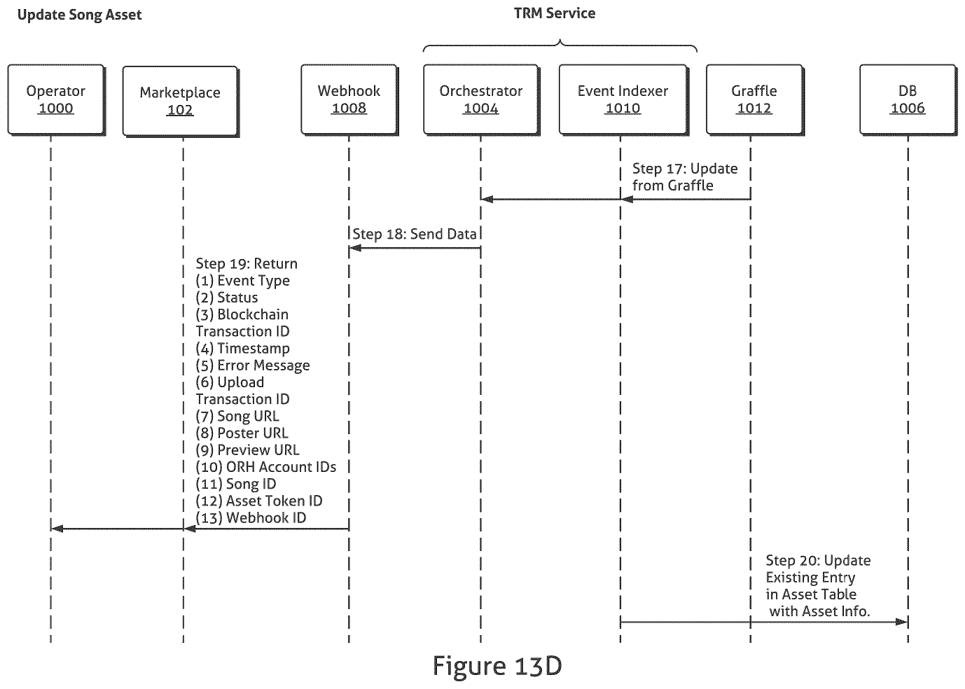

FIGS. 13A-13D illustrate a non-limiting example of a song asset update process consistent with certain embodiments disclosed herein. The operator 1000 may log in to the marketplace service 102 using associated authentication credentials. The marketplace 102 may authenticate the operator 1000 based on the provided credentials and communicate an authentication result to the operator and/or their associated system and/or device 1000.

Upon successfully authenticating with the marketplace service 102, the operator 1000 may provide the marketplace service 102 with various information relating to an asset update. This information may, in some embodiments, comprise various ID information relating to the song, which may include rightsholder information, and/or metadata associated with the song. For example and without limitation, the operator 1000 may provide the marketplace service 102 with one or more of a an asset ID, an associated rightsholder account ID with the marketplace service 102 (e.g., an ORH account ID), a song file name and/or an associated hash of the song file, a trailer video file name and/or an associated hash of the trailer video file, a lyric file name and/or an associated hash of the lyric file, a trailer audio file name and/or an associated hash of the trailer audio file, a poster and/or other promotional content file name and/or an associated hash of the poster and/or other promotional content. As detailed above, in various embodiments, certain information communicated by the operator 1000 to the marketplace service 102 in connection with a token creation request may be expressed in metadata associated with the song.

The marketplace service 102 may communicate a request to update a song asset to a packaging service 1002, which in some embodiments may be associated with a TRM service (and/or may be service of the marketplace service and/or another media service). In some embodiments, the request may comprise in information relating to the song asset received from the operator 1000 (e.g., some and/or all of the information received in the illustrated Step 4). The packaging service 1002 may, in response to the request, create a webhook ID associated with the request.

The packaging service 1002 may return a pre-signed URL to the marketplace service 102 which may be used to upload any asset update files (if need) to the packaging service 1002. The packaging service 1002 may further return asset ID and/or webhook ID information. The marketplace service 102 may, if applicable, upload the file for the updated song asset to the packaging service 1002. The packaging service 1002 may then proceed to package the file(s).

The packaging service 1002 may then provide the data relating to the song asset update received from the operator 1000 (e.g., some and/or all of the information received in the illustrated Step 4) and/or the webhook ID to an orchestrator service 1004 of the TRM service. The uploaded data may be provided by the orchestrator service 1004 to the blockchain connector 212 for use in updating the blockchain 212.

The blockchain connector service 212 may retrieve a private key(s) from a key vault and/or other secure repository and generate and sign a transaction assertion using the private key(s). The signed transaction may be sent, by the blockchain connector service 212 to a ledger service for recordation in a blockchain 214 and/or other trusted ledger. The ledger service may update the asset token in the blockchain 214.

After minting the token, the blockchain 214 may update the Graffle service 1012. The update may be shared with an event indexer service 1010 of the TRM service, which may share the update and/or associated data with the orchestrator service 1004 and/or a webhook service 1008. Based on receiving the update, the webhook service 1008, which may facilitate event-driven communication between the orchestrator service 1004 and/or the marketplace service 102, may direct the marketplace service 102 to return information relating to the minting of the token to the operator 1000.

For example, as shown, the marketplace service 102 may return one or more of an indication of an event type (e.g., asset update), an associated status (e.g., asset updated), a blockchain transaction ID, a timestamp, any error messages, upload transactions ID, song links, poster links, preview links, other IDs, which may comprise one or more of a song ID, a corresponding asset token ID, a rightsholder ID (e.g., a ORH account ID), and/or a webhook ID, and/or any other information relating to the update of the of the token. The event indexer service 1010 of the TRM service may update one or more tables to reflect the asset update transaction. For example, an existing asset entry in the asset table managed by the DB service 1006 may be updated to reflect the update.

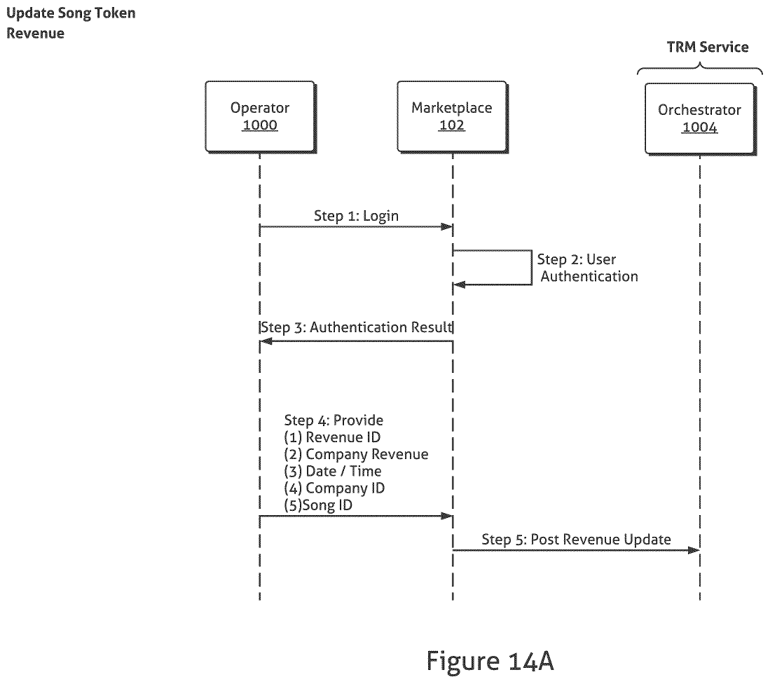

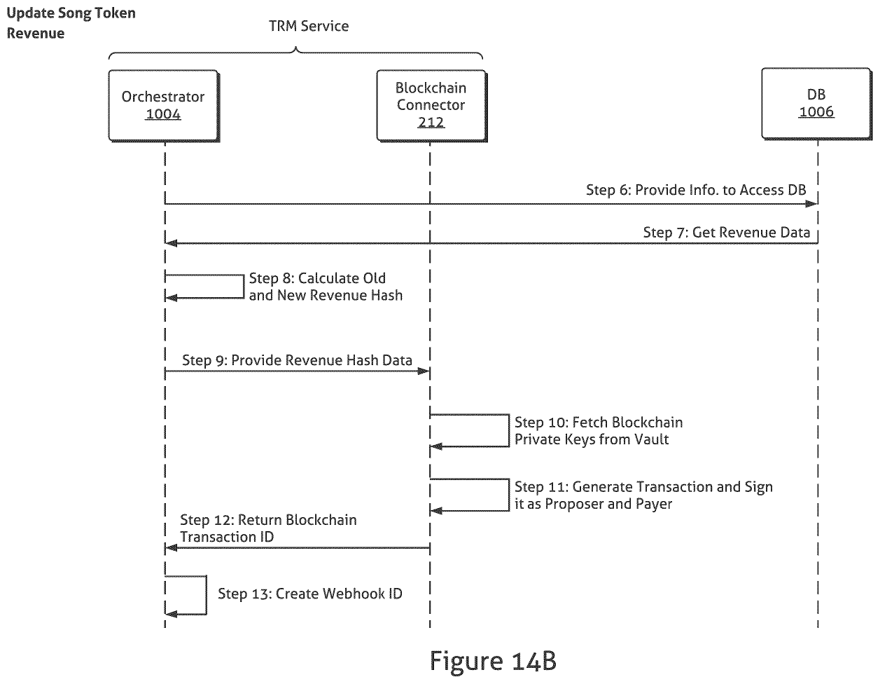

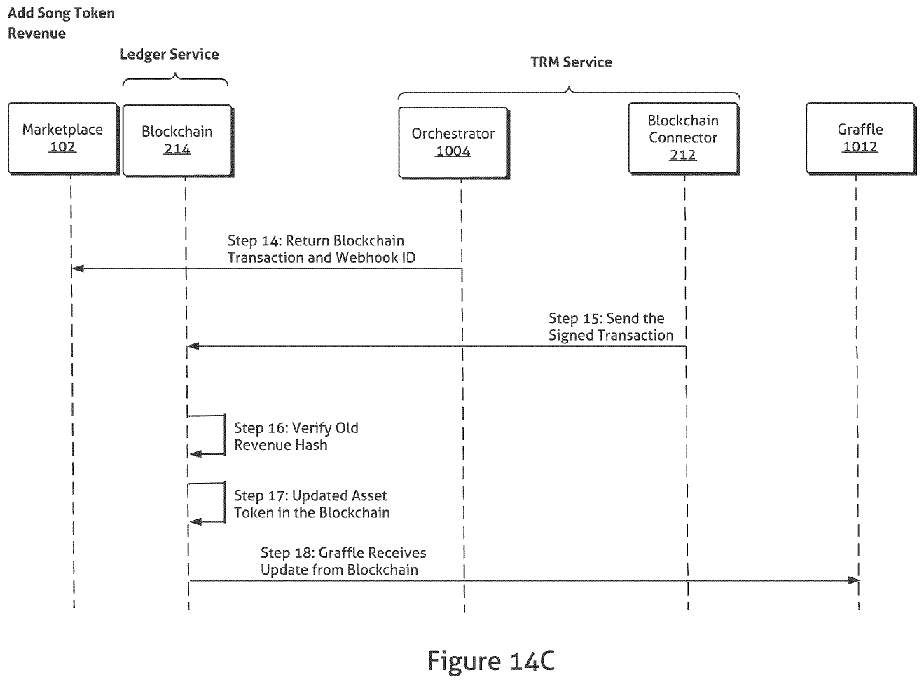

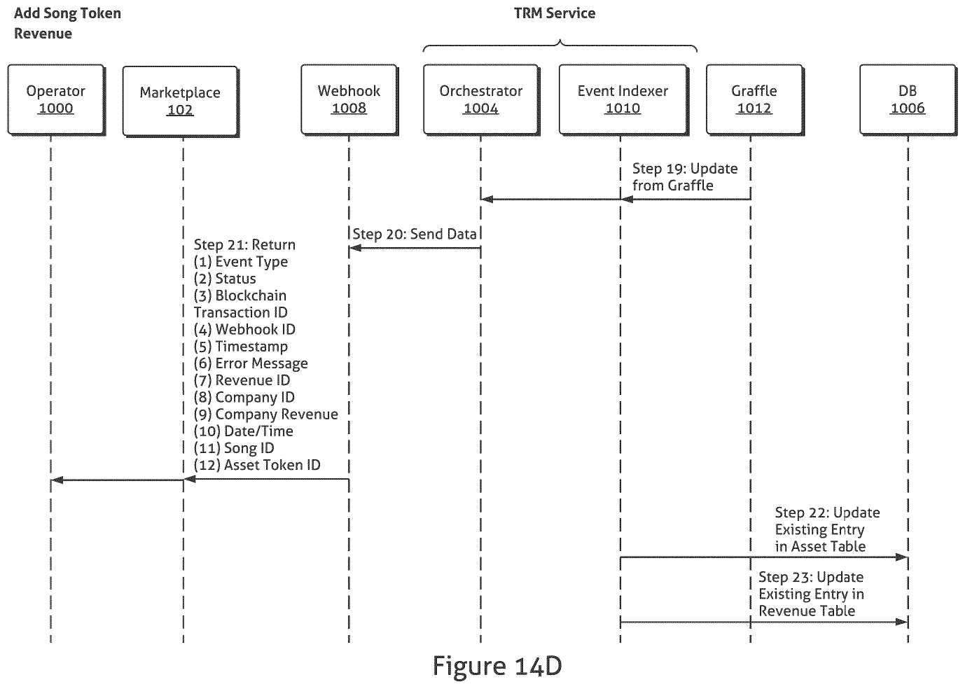

FIGS. 14A-14D illustrate a non-limiting example of a song token revenue update process consistent with certain embodiments disclosed herein. The operator 1000 may log in to the marketplace service 102 using associated authentication credentials. The marketplace 102 may authenticate the operator 1000 based on the provided credentials and communicate an authentication result to the operator and/or their associated system and/or device 1000.

Upon successfully authenticating with the marketplace service 102, the operator 1000 may provide the marketplace service 102 with various information relating to updating revenue associated with a particular token. This information may, in some embodiments, comprise one or more of revenue information (e.g., revenue ID and/or company revenue information), date and/or time information (e.g., timestamp information relating to the revenue add transaction and/or individual revenue transactions subject to the revenue update transactions), an indication of a company ID adding the revenue, and an ID of the associated song.

The marketplace service 102 may communicate a request to update song token revenue to an orchestrator service 1004 of a TRM service. For example, the orchestrator service 1004 may receive an update revenue request (e.g., revenue_id_5, company_id_5′, datetime_5′, company_revenue_5′) for a certain song_token (e.g., identified with song_id) from the marketplace service 102.

The orchestrator service 1004 may provide information to access and/or retrieve revenue data information to the DB service 1006 (e.g., access credentials and/or investor data retrieval information). The DB service 1006 may provide the orchestrator service 1004 with the requested revenue information. For example, the orchestrator service 1004 may receive the previous revenue for the identified song token. In certain implementations, due to computation resources and/or performance limitations, in some embodiments a recent n numbers of revenue information may be retrieved.

Based on the received information, the orchestrator service 1004 may calculate an old revenue hash and a new revenue hash. For example and without limitation, the orchestrator service 1004 may calculate:
revenue_hash=SHA256[[song_id, company_id_1, datetime_1, company_revenue_1], [song_id, company_id_2, datetime_2, company_revenue_3], . . . [song_id, company_id_5, datetime_5, company_revenue_5], . . . [song_id, company_id_9, datetime_9, company_revenue_9]]
new_revenue_hash=SHA256[[song_id, company_id_1, datetime_1, company_revenue_1], [song_id, company_id_2, datetime_2, company_revenue_3], . . . [song_id, company_id_5′, datetime_5′, company_revenue_5′], . . . [song_id, company_id_9, datetime_9, company_revenue_9]]

The revenue hash data may be provided by the orchestrator service 1004 to the blockchain connector service 212. In some embodiments, the orchestrator service 1004 may send the revenue_hash to the blockchain connector service 212 that may verify the hash against the corresponding song token. The blockchain connector service 212 may retrieve a private key(s) from a key vault and/or other secure repository and generate and sign a transaction assertion using the private key(s). An ID of the signed transaction may be sent, by the blockchain connector service 212, to the orchestrator service 1004. The orchestrator service 1004 may generate webhook ID associated with the transaction.

The orchestrator service 1004 may return the blockchain transaction and/or webhook ID to the marketplace service 1002. The signed transaction may be sent by the blockchain connector service 212 to the blockchain 214 of the ledger service for recordation. The ledger service may verify the old revenue hash. For example, the blockchain connector service 212 may coordinate with the blockchain 214 to verify the current_revenue_hash against the corresponding song token. If verified, the ledger service may update the asset token to reflect the updated revenue. For example, the orchestrator service 1004 may send the new_revenue_hash to the blockchain connector service 212 that may include the new_revenue_hash as a part of the signed transaction to record it with the asset token.

After updating the revenue information, the blockchain 214 may update the Graffle service 1012. The update may be shared with an event indexer service 1010 of the TRM service, which may share the update and/or associated data with the orchestrator service 1004 and/or a webhook service 1008. Based on receiving the update, the webhook service 1008 may direct the marketplace service 102 to return information relating to the minting of the token to the operator 1000.

For example, as shown, the marketplace service 102 may return one or more of an indication of an event type (e.g., revenue update), an associated status (e.g., revenue added), a blockchain transaction ID, a timestamp, any error messages, revenue ID, company ID, company revenue information, dates and/or times associated with the updated revenue, other IDs, which may comprise one or more of a song ID, a corresponding asset token ID, and/or a webhook ID, and/or any other information relating to the transfer of ownership of the of the token.

The event indexer service 1010 of the TRM service may update one or more tables to reflect the revenue update transaction. For example, an existing entry in an asset table managed by the DB service 1006 may be updated, an existing entry may be created in a revenue table managed by the DB service 1006 to reflect the added revenue, and/or the like.

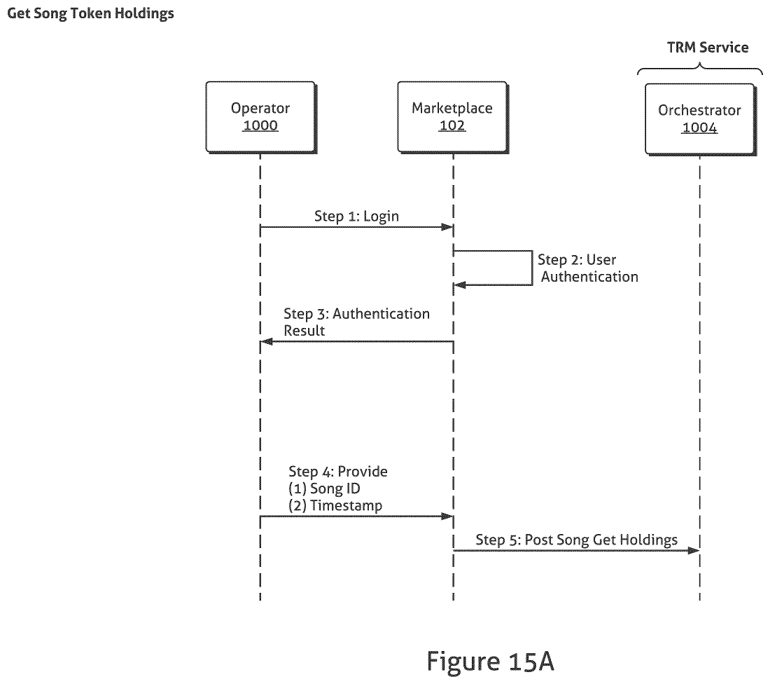

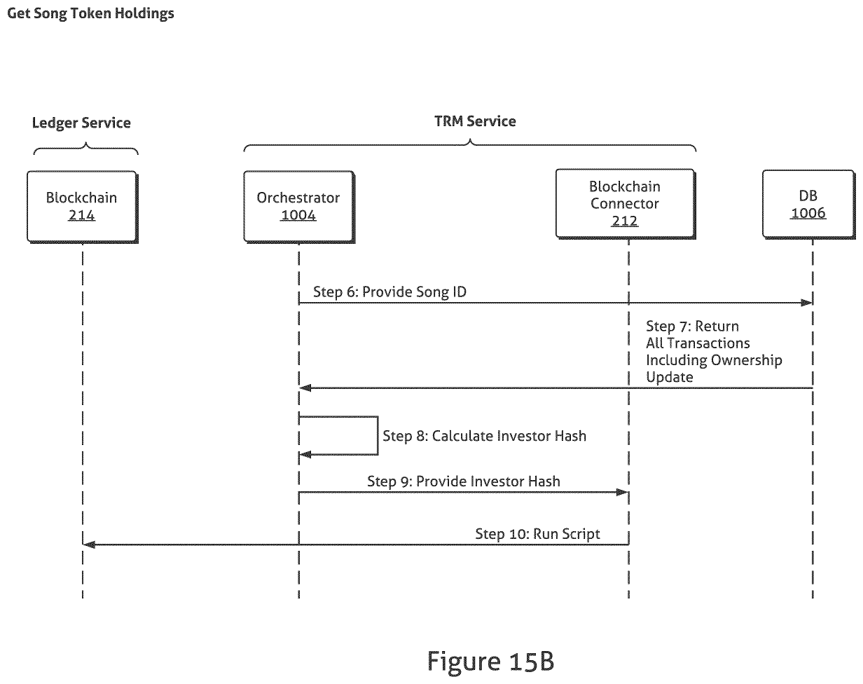

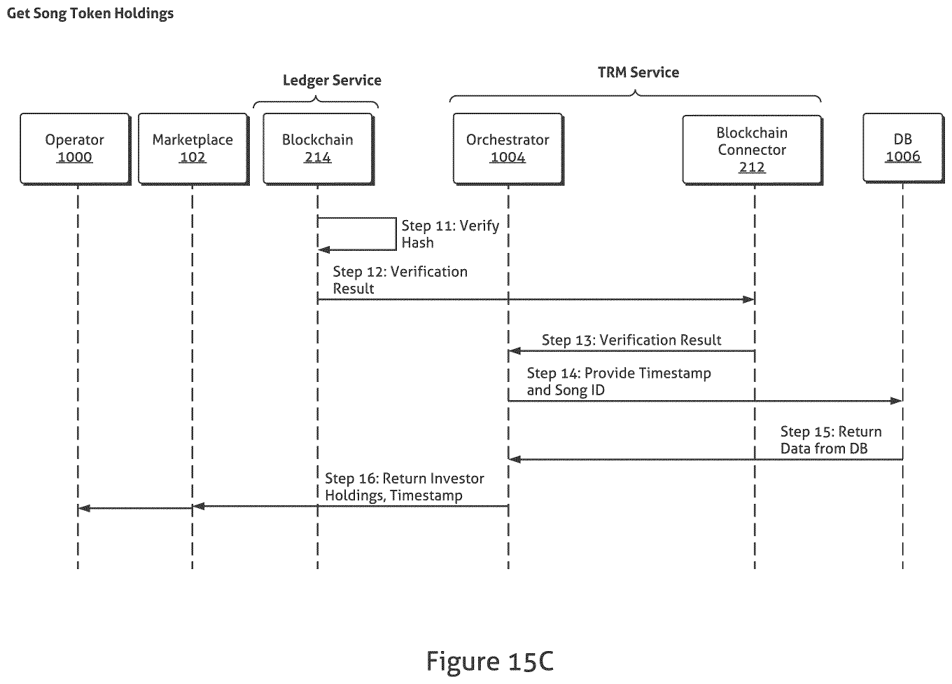

FIGS. 15A-15C illustrate a non-limiting example of a song token holding retrieval update process consistent with certain embodiments disclosed herein. The operator 1000 may log in to the marketplace service 102 using associated authentication credentials. The marketplace 102 may authenticate the operator 1000 based on the provided credentials and communicate an authentication result to the operator and/or their associated system and/or device 1000.

Upon successfully authenticating with the marketplace service 102, the operator 1000 may provide the marketplace service 102 with various information relating to retrieving holding information associated with a particular token. This information may, in some embodiments, comprise one or more of a song ID and/or a timestamp.

The marketplace service 102 may communicate a holding retrieval request to an orchestrator service 1004 of a TRM service. The orchestrator service 1004 may issue a request to the DB service 1006 to retrieve transactions associated with the song ID. The DB service 1006 may return available transactions (which may include ownership updates) to the orchestrator service 1004. For example, the orchestrator service 1004 may retrieve the existing investor_holdings and their transaction_timestamp(s) from the DB service 1006. In some embodiments, due to computational resources and/or performance limitations, in some embodiments a recent n numbers of investor_holdings may be retrieved.

The orchestrator service 1004 may calculate an investor hash for a particular investor and provide the investor hash to the blockchain connector service 212. For example and without limitation, the orchestrator service 1004 may calculate:
investor_hash=investor_hash=SHA256 [[transfer_ownership_0, investor_holdings_0, transaction_timestamp_0], [transfer_ownership_1, investor_holdings_1, transaction_timestamp_1], [transfer_ownership_2, investor_holdings_2, transaction_timestamp_2], . . . [transfer_ownership_9, investor_holdings_9, transaction_timestamp_9]].

The blockchain connector service 212 may run a script with the ledger service to retrieve information recorded in the blockchain 214 associated with the investor. The ledger service may verify that the hash is recorded in the blockchain 214, returning a verification result to the blockchain connector service 212, which may share it with the orchestrator service 1004.

Upon receiving the verification, the orchestrator service 1004 may provide the timestamp and song ID to the DB service 1006 and request that investor holding information be returned. For example, the orchestrator service 1004 and/or the DB service 1006 may search for a transaction_timestamp which is: (1) older than the timestamp provided at illustrated Step 5; and (2) nearest to the timestamp provided at illustrated Step 5. The DB service 1006 may return the investor holding information to the orchestrator service 1004, which may share it with the marketplace service 102 and/or the operator 1000.

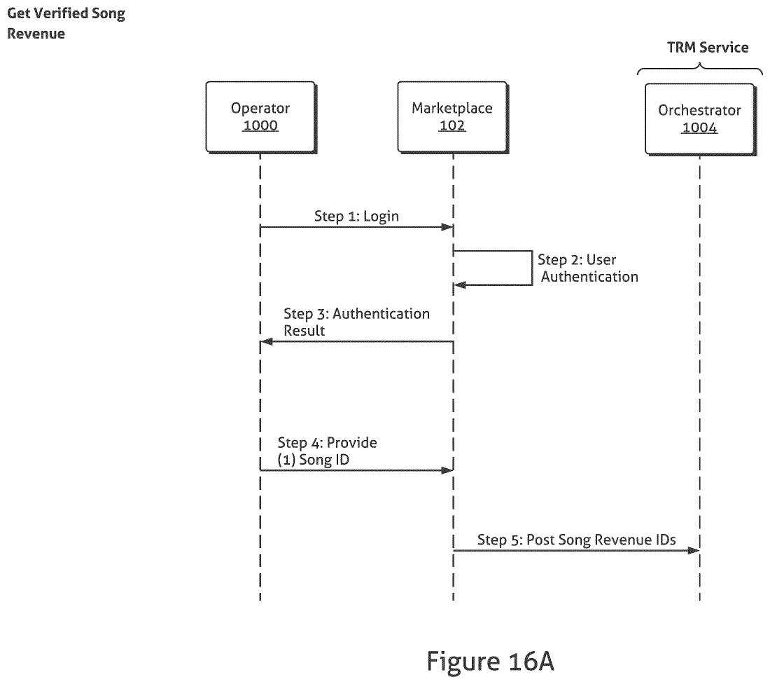

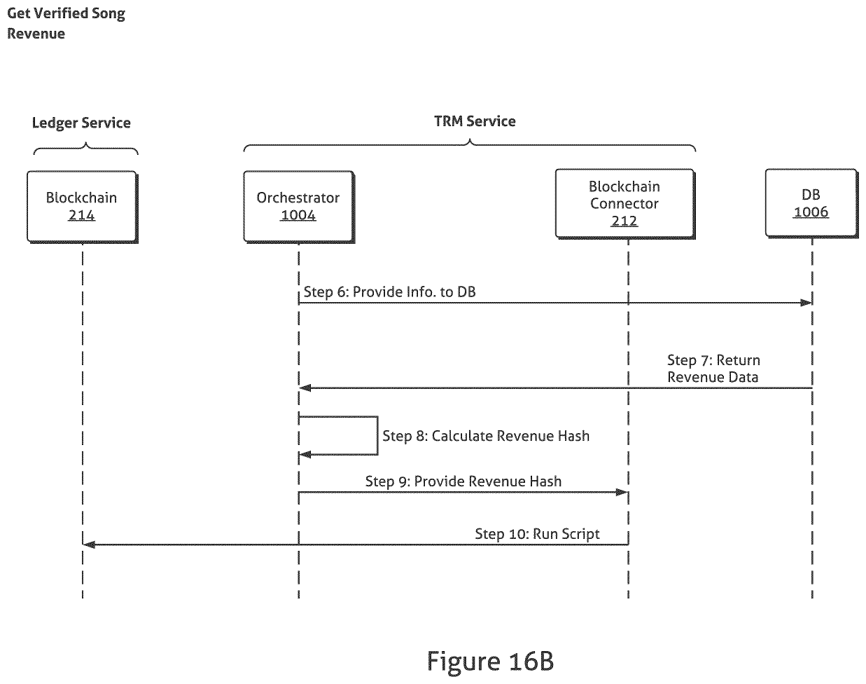

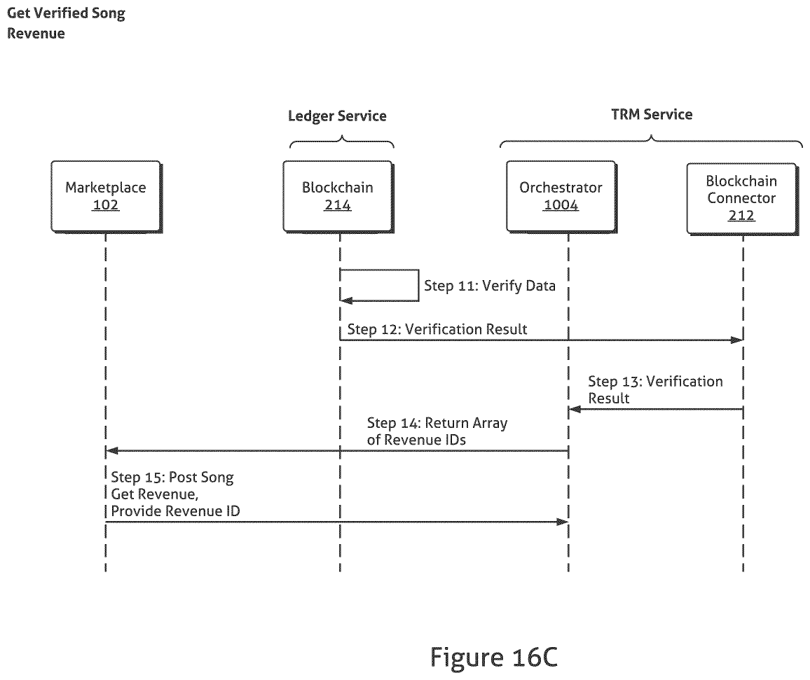

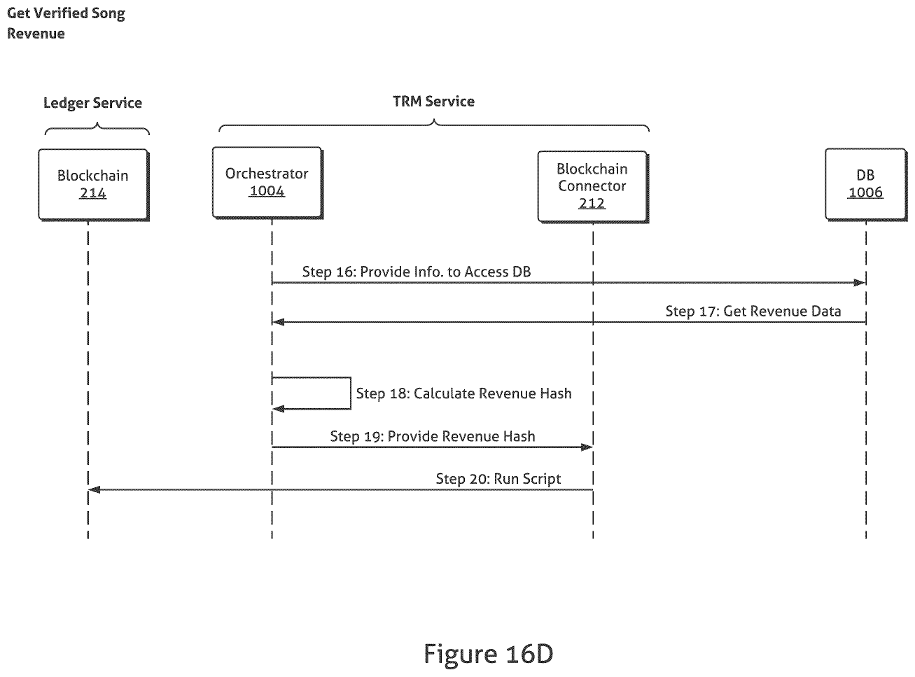

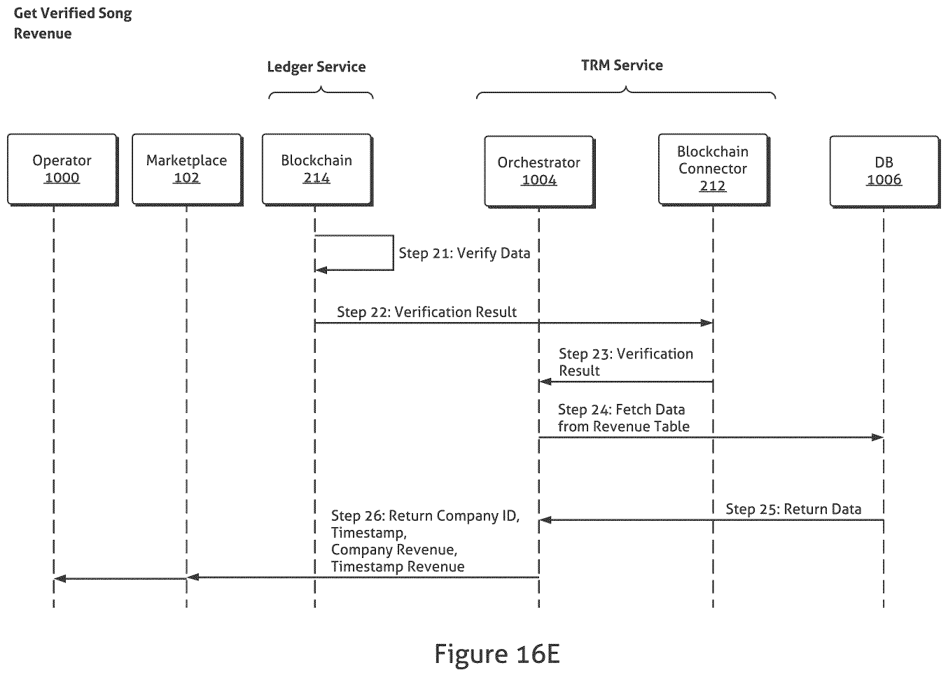

FIGS. 16A-16E illustrate a non-limiting example of a verified song revenue retrieval process consistent with certain embodiments disclosed herein. The operator 1000 may log in to the marketplace service 102 using associated authentication credentials. The marketplace 102 may authenticate the operator 1000 based on the provided credentials and communicate an authentication result to the operator and/or their associated system and/or device 1000.

Upon successfully authenticating with the marketplace service 102, the operator 1000 may provide the marketplace service 102 with various information relating to retrieving verified song revenue information associated with a particular token. This information may, in some embodiments, comprise a song ID.

The marketplace service 102 may communicate a verified song revenue information retrieval request to an orchestrator service 1004 of a TRM service. In some embodiments, the retrieval request may comprise the song ID. The orchestrator service 1004 may issue a request to the DB service 1006 to retrieve revenue data (e.g., an array of revenue IDs) associated with the song ID. The DB service 1006 may return available revenue data (e.g., an array of revenue IDs) to the orchestrator service 1004. Based on the received revenue data, the orchestrator service 1004 may calculate a revenue hash (e.g., calculate a hash based on one or more of a song ID, a company ID, date and/or time information, and/or revenue information) and provide it to the blockchain connector service 212.

The blockchain connector service 212 may run a script with the ledger service to verify that information is recorded in the blockchain 214 associated with the revenue hash. The ledger service may verify that the hash is recorded in the blockchain 214, returning a verification result to the blockchain connector service 212 which may share it with the orchestrator service 1004.

The orchestrator service 1004 may, based on the verification, return an array of revenue IDs to the marketplace service 102. The marketplace service 102 may communicate a retrieval request to the orchestrator service 1004 to retrieve revenue information based on the revenue ID information. The orchestrator service 1004 may issue a request to the DB service 1006 to retrieve revenue data associated with the revenue ID(s). The DB service 1006 may return available revenue data to the orchestrator service 1004. For example and without limitation, the orchestrator service may receive a revenue_id (e.g., revenue_id_5) for a certain song_token from the marketplace service 102. The orchestrator service 1004 may retrieve the previous revenue for the song token from the DB service 1006. Due to computational resources and/or performance limitations, in some embodiments a recent n numbers of revenue may be retrieved.

Based on the received revenue data, the orchestrator service 1004 may calculate a revenue hash and provide it to the blockchain connector service 212. For example and without limitation, the orchestrator service 104 may calculate:
revenue_hash=SHA256[[song_id, company_id_1, datetime_1, company_revenue_1], [song_id, company_id_2, datetime_2, company_revenue_3], . . . [song_id, company_id_5, datetime_5, company_revenue_5], . . . [song_id, company_id_9, datetime_9, company_revenue_9]]

The orchestrator service 1004 may send the revenue_hash to the blockchain connector service 212, and the blockchain connector service 212 may verify the hash against the corresponding song token. For example, the blockchain connector service 212 may run a script with the ledger service to verify that information is recorded in the blockchain 214 associated with the revenue hash. The ledger service may verify that the hash is recorded in the blockchain 214, returning a verification result to the blockchain connector service 212 which may share it with the orchestrator service 1004. Based on the received verification, the orchestrator service 1004 may fetch the data from a revenue table of the DB service 1006. The DB service 1006 may return the retrieved data to the orchestrator service 1004, which may return to the marketplace 102 and/or operator 1000 the retrieved company ID, timestamp, company revenue, and/or timestamp revenue information (e.g., company_id_5, datetime_5, company_revenue_5, timestamp_revenue_5).

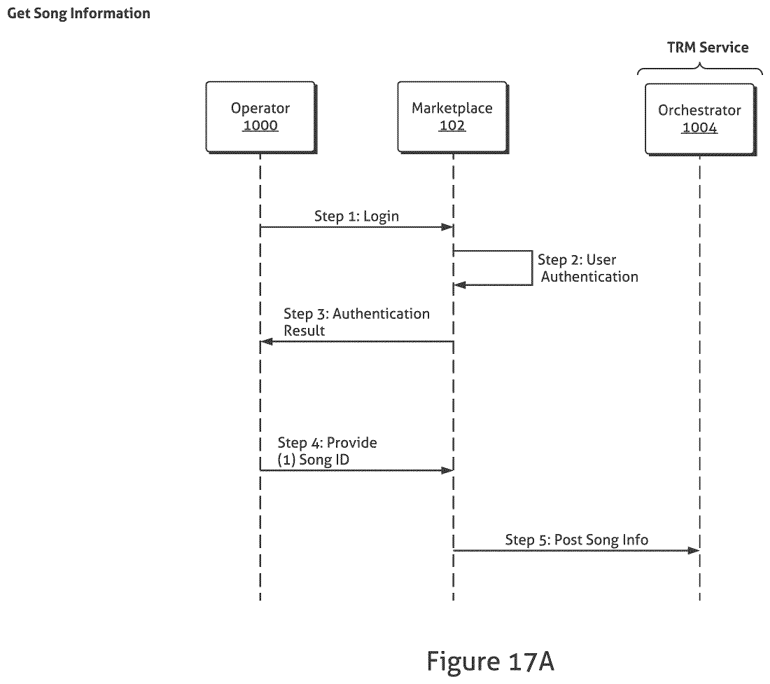

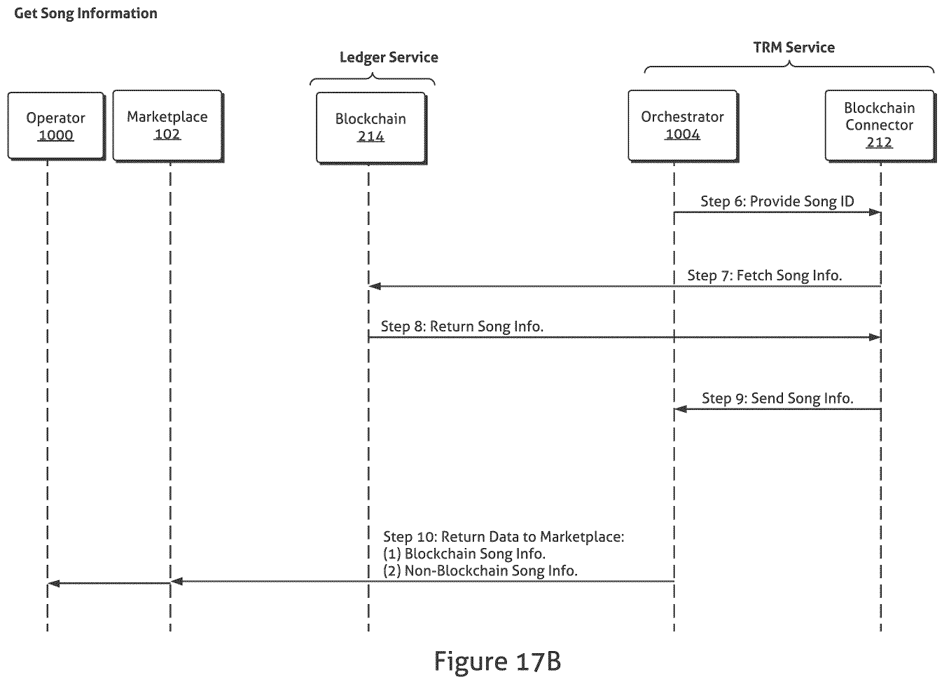

FIGS. 17A-17B illustrate a non-limiting example of a song information retrieval process consistent with certain embodiments disclosed herein. The operator 1000 may log in to the marketplace service 102 using associated authentication credentials. The marketplace 102 may authenticate the operator 1000 based on the provided credentials and communicate an authentication result to the operator and/or their associated system and/or device 1000.

Upon successfully authenticating with the marketplace service 102, the operator 1000 may provide the marketplace service 102 with various information relating to retrieving song information associated with a particular token. This information may, in some embodiments, comprise a song ID.

The marketplace service 102 may communicate a verified song information retrieval request to an orchestrator service 1004 of a TRM service. In some embodiments, the retrieval request may comprise the song ID. The orchestrator service 1004 may provide the song ID to a blockchain connector service 212, which may fetch the song information associated with the song ID from the blockchain 214 managed by the ledger service. The blockchain connector service 212 may send the song information to the orchestrator service, which may return the data to the marketplace service 102 and/or the operator 1000. The data may comprise, for example and without limitation, the song information retrieved from the blockchain 214 and/or other song information that may not be stored and/or otherwise managed on the blockchain 214 (e.g., information stored and/or managed by a DB service).

For example and without limitation, the orchestrator service 1004 may return to the marketplace service 102 and/or the operator 1000 one or more of a song ID, title, description, URL, song thumbnail URL, ORH information, ISRC information, performer information, lyricist information, composer information, arranger information, token information, owner information, owner hash information, revenue hash information, metadata information, preview information (e.g., trailer URL, trailer audio URL, etc.), and/or the like.

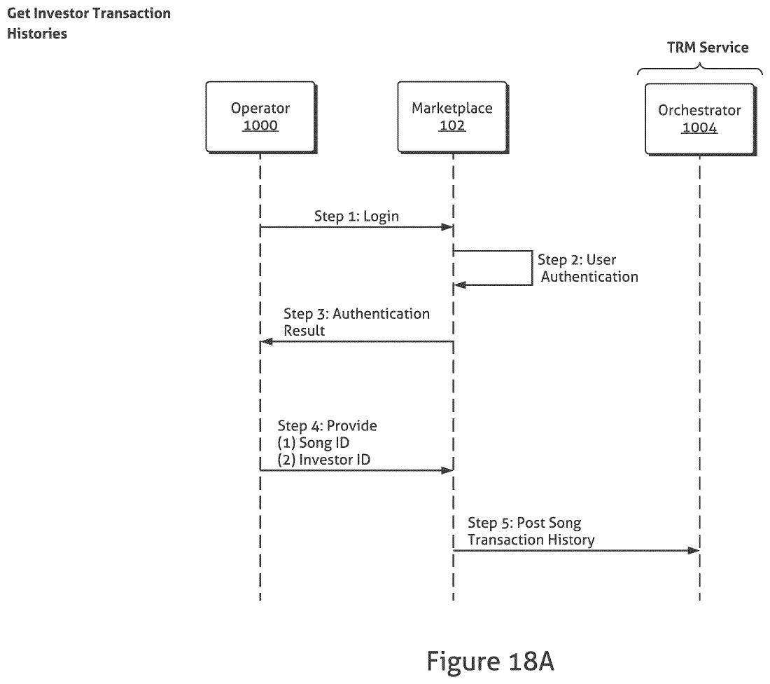

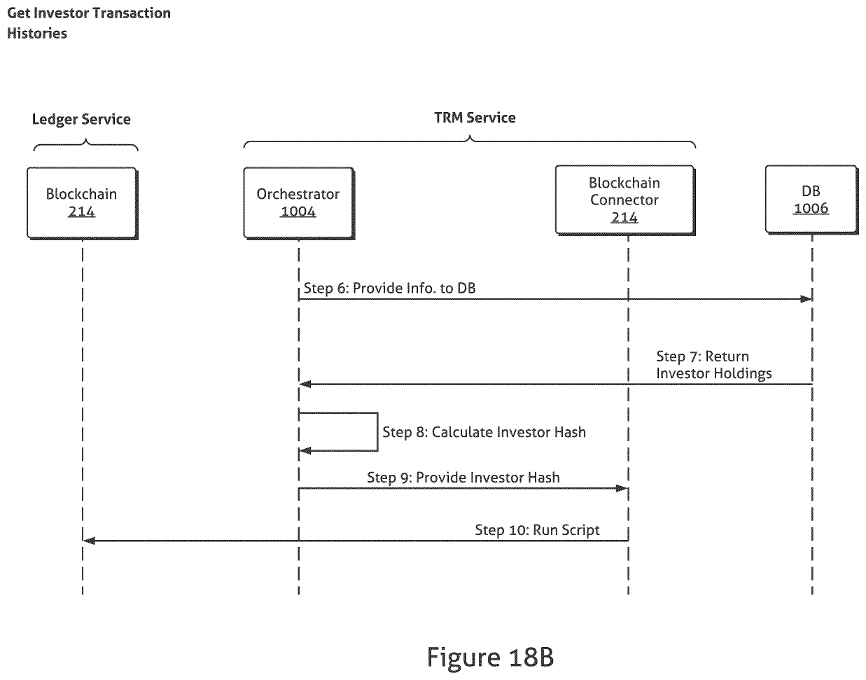

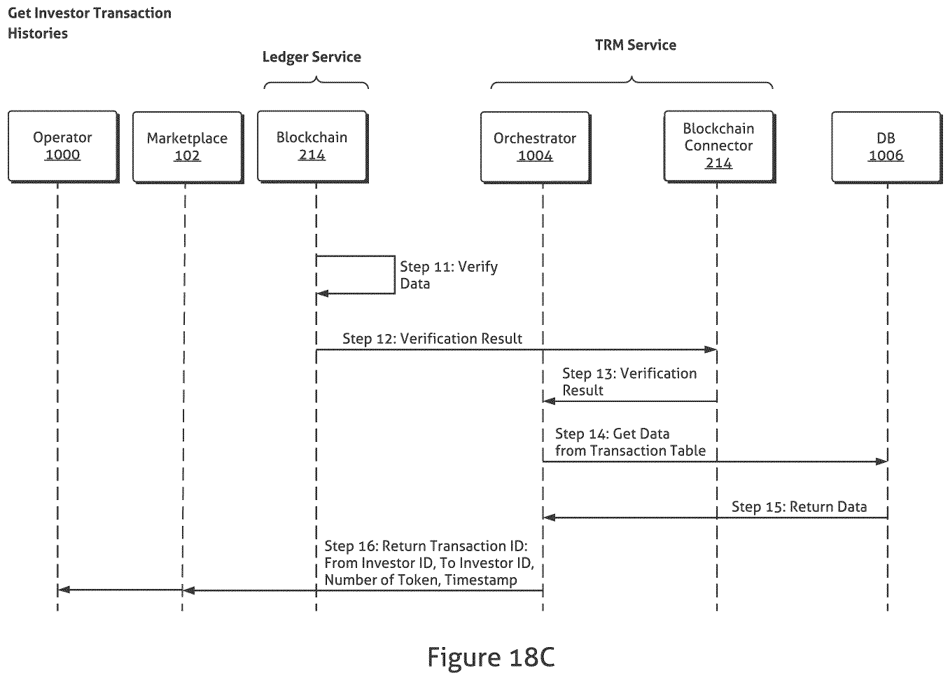

FIGS. 18A-18C illustrate a non-limiting example of an investor transaction history retrieval process consistent with certain embodiments disclosed herein. The operator 1000 may log in to the marketplace service 102 using associated authentication credentials. The marketplace 102 may authenticate the operator 1000 based on the provided credentials and communicate an authentication result to the operator and/or their associated system and/or device 1000.

Upon successfully authenticating with the marketplace service 102, the operator 1000 may provide the marketplace service 102 with various information relating to retrieving song information associated with a particular token. This information may, in some embodiments, comprise a song ID and/or an investor ID. Consistent with embodiments disclosed herein, in some embodiments, the investor ID information may reflect certain fractional ownership of an asset between multiple investors. For example and without limitation, the investor ID information could comprise:

“investor holdings”: {
“investor_id_1”: 70,
“investor_id_2”: 30
},

The marketplace service 102 may communicate an investor transaction history retrieval request to an orchestrator service 1004 of a TRM service. The orchestrator service may issue a request to the DB service 1006 to retrieve investor holding information. The DB service 1006 may return available investor holding information to the orchestrator service 1004. For example and without limitation, the orchestrator service 1004 may receive prior investor_holdings information and their associated transaction_timestamp(s) from the DB service 1006. Due to computation resources and/or performance limitations, in some embodiments a recent n numbers of investor_holdings may be retrieved.

Based on the received investor holding data, the orchestrator service 1004 may calculate an investor hash and provide it to the blockchain connector service 212. For example and without limitation, the orchestrator service 1004 may calculate the following:
investor_hash=investor_hash=SHA256 [[transfer_ownership_0, investor_holdings_0, transaction_timestamp_0], [transfer_ownership_1, investor_holdings_1, transaction_timestamp_1], [transfer_ownership_2, investor_holdings_2, transaction_timestamp_2], . . . [transfer_ownership_9, investor_holdings_9, transaction_timestamp_9]]

The blockchain connector service 212 may run a script with the ledger service to verify that information is recorded in the blockchain 214 associated with the investor hash.

For example and without limitation, the blockchain connector service 212 may verify the hash against the corresponding song token. The ledger service may verify that the hash is recorded in the blockchain 214, returning a verification result to the blockchain connector service 212 which may share it with the orchestrator service 1004.

Based on the received verification, the orchestrator service 1004 may query the DB service 1006 to receive information associated with the investor from a transaction table managed by the DB service 1006. The DB service 1006 may return the relevant data to the orchestrator service 1004 which in turn may return to the marketplace service 102 (which may be shared with the operator 100) transaction ID, transferor investor ID (i.e., the “from” investor ID, transferee investor ID (i.e., the “to” investor ID), a number of tokens associated with the transfer, and/or timestamp information. For example and without limitation, once the hash verification is successfully completed, the orchestrator service 1004 may return transaction_timestamp(s) and transfer_onwershp(s) where the given investor_id (e.g. investor_id_6) is included as from_investor_id or to_investor_id.

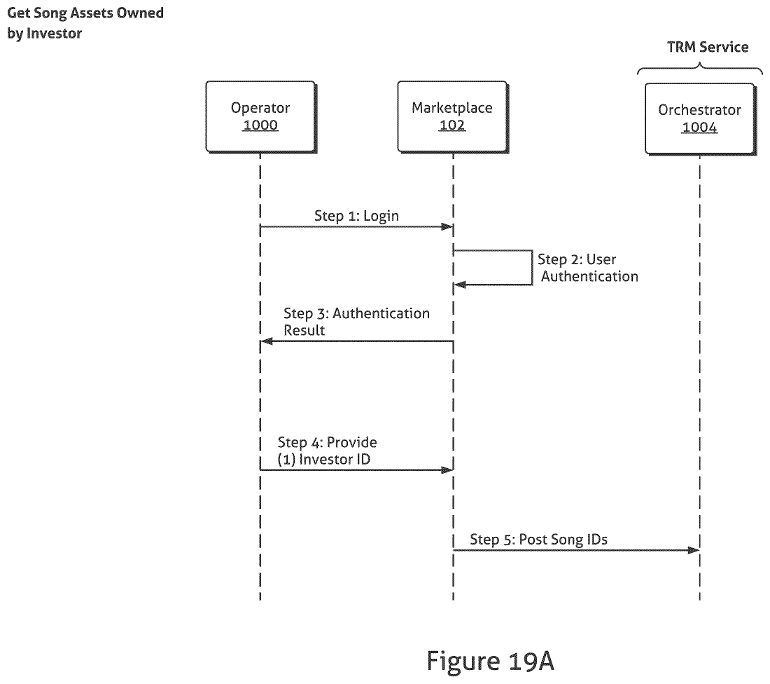

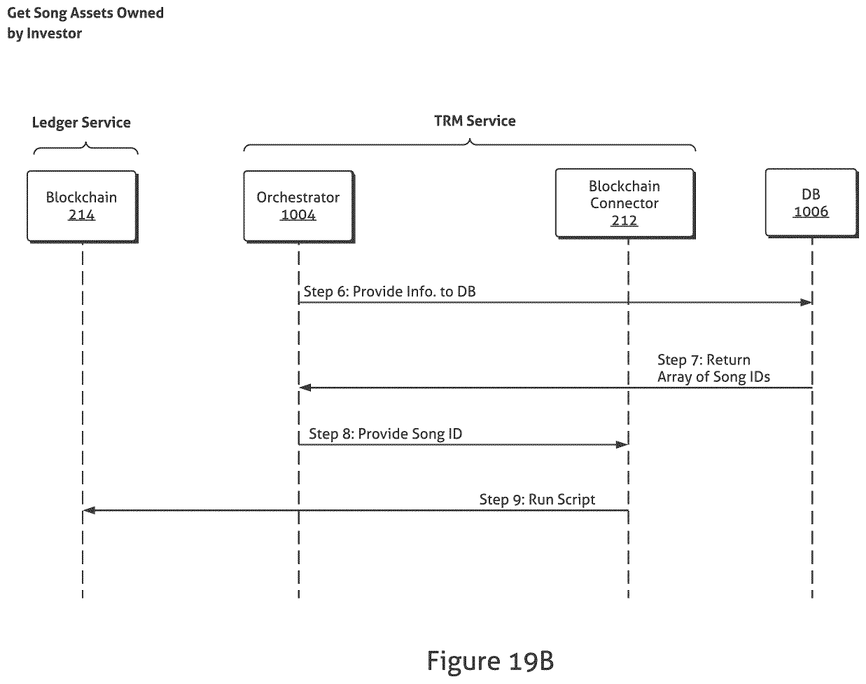

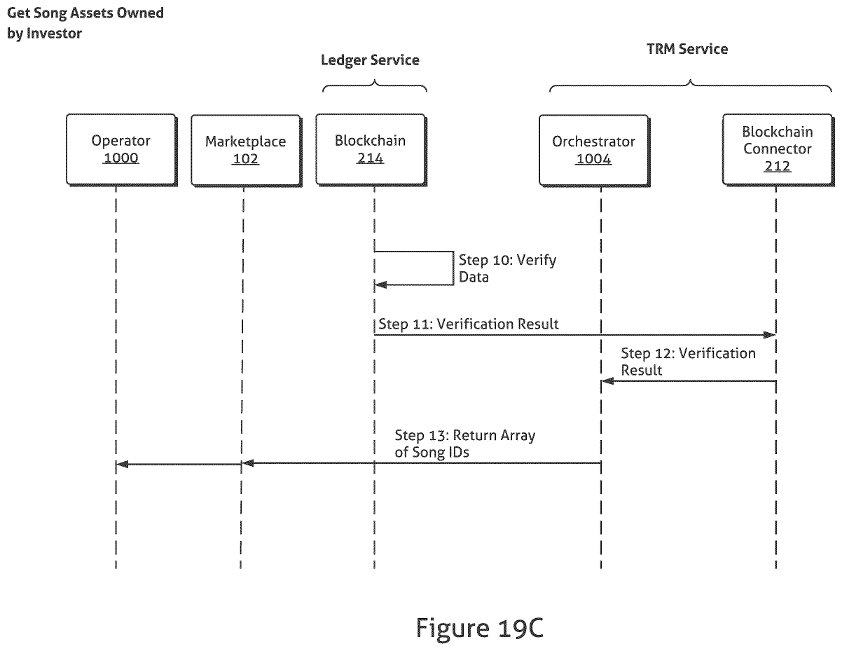

FIGS. 19A-19C illustrate a non-limiting example of a retrieval process for song assets owned by an investor using a blockchain ledger consistent with certain embodiments disclosed herein. The operator 1000 may log in to the marketplace service 102 using associated authentication credentials. The marketplace 102 may authenticate the operator 1000 based on the provided credentials and communicate an authentication result to the operator and/or their associated system and/or device 1000.

Upon successfully authenticating with the marketplace service 102, the operator 1000 may provide the marketplace service 102 with various information relating to retrieving song assets owned by a particular investor. This information may, in some embodiments, comprise an investor ID.

The marketplace service 102 may communicate a song asset investor ownership request to an orchestrator service 1004 of a TRM service. The orchestrator service 1004 may issue a request to the DB service 1006 to retrieve investor holding information. The DB service 1006 may return one or more song IDs (e.g., an array of song IDs) to the orchestrator service 1004. The orchestrator service 1004 may provide one or more of the song IDs to the blockchain connector service 212.

The blockchain connector service 212 may run a script with the ledger service to verify that information is recorded in the blockchain 214 associated song ID(s) and the associated investor. The ledger service may verify that a corresponding hash is recorded in the blockchain 214, returning a verification result to the blockchain connector service 212 which may share it with the orchestrator service 1004. If verified, the array of song ID(s) may be returned to the marketplace service 102 from the orchestrator service 1004 (and/or shared by the marketplace service 102 with the operator 1000).

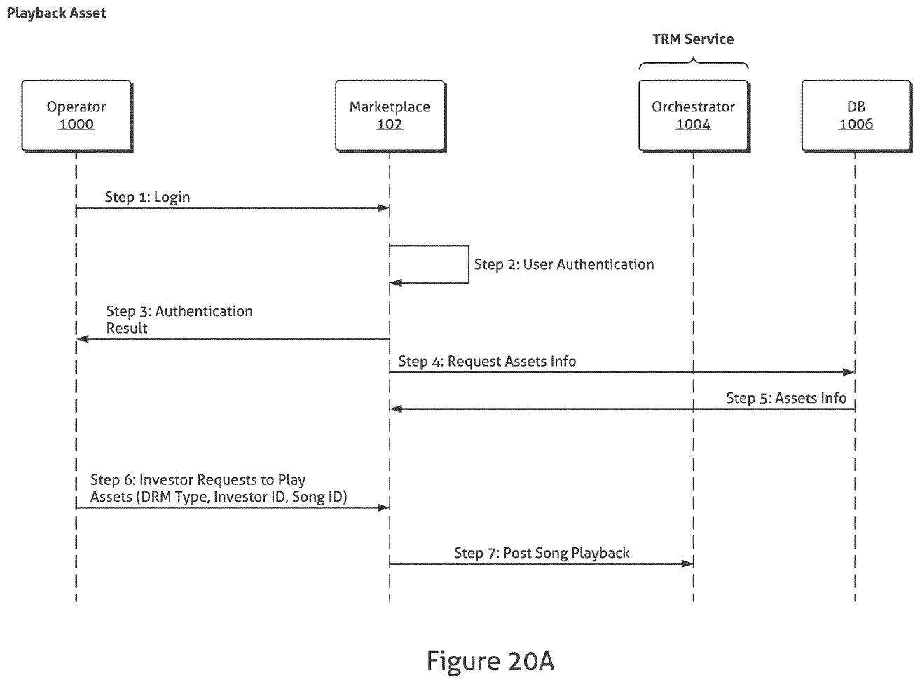

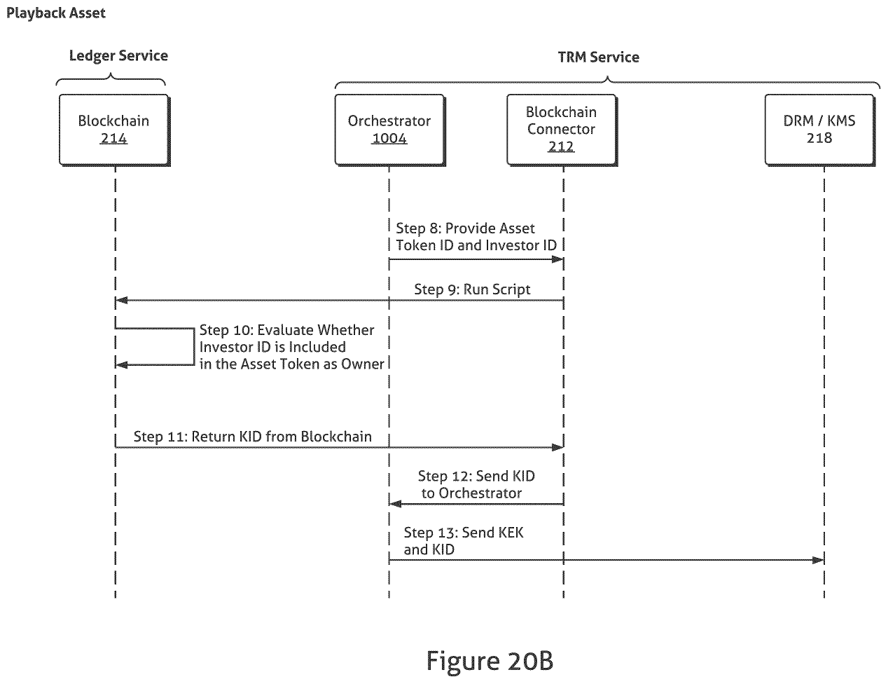

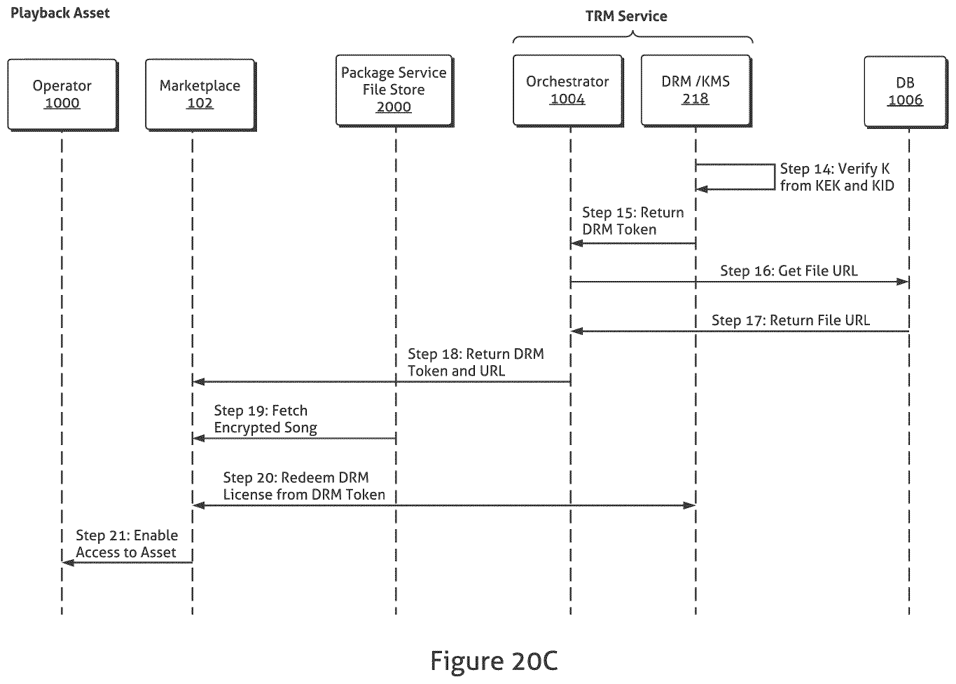

FIGS. 20A-20C illustrate a non-limiting example of an asset playback process consistent with certain embodiments disclosed herein. The operator 1000 may log in to the marketplace service 102 using associated authentication credentials. The marketplace 102 may authenticate the operator 1000 based on the provided credentials and communicate an authentication result to the operator and/or their associated system and/or device 1000.

The marketplace service 102 may query the DB service 1006 to identify available assets for playback, receiving a response from the DB service 1006 with relevant asset information. The operator 1000 may communicate a request to play an available asset to the marketplace service 102. In some embodiments, the request may comprise, for example and without limitation, one or more of a DRM type, an investor ID, and/or a song ID. The marketplace service 102 may communicate a corresponding request to the orchestrator service 1004 of the TRM service.

The orchestrator service 1004 may provide asset token ID and/or investor ID information to the blockchain connector service 212, which may run a script causing the ledger service to evaluate whether the investor ID is recorded in the blockchain 214 in the specified asset token information as an owner. If so, the blockchain 214 and/or associated ledger service may return a KID associated with the asset to the blockchain connector service 212.

The blockchain connector 212 may send the received KID to the orchestrator service 1004. The orchestrator service may send the KID and/or a key encryption key (“KEK”) to a DRM service 218 (which may be part of the TRM service and/or be a separate system and/or service). The DRM service 218 may verify the content key based on the received KEK and KID and issue a DRM token to the orchestrator service 1004 upon successful verification. The orchestration may retrieve a file link (e.g., a file URL) for the requested asset from the DB service 1006, and return the DRM token and URL to the marketplace service 102.

The marketplace service 100 may retrieve the encrypted asset using the file link from a package service file store 2000, and coordinate with the DRM service 218 to redeem a DRM license using the DRM token. Using the redeemed DRM license, the marketplace service 102 may enable access (e.g., playback) of the song by the operator 1000.

Examples of Artist Interaction(s) with a Content Distribution Service

Non-limiting examples of artist interactions with a content distribution service and/or related systems and/or services are detailed below.

In some embodiments, an artist may create an account with the content distribution service, logging in via any suitable method (e.g., via SSO services). Logged in users can choose to access via an interface an “Artist/Creator” tab for uploading content and/or a “Personal Tab” for purchasing other content.

When accessing the “Artist/Creator” tab, the artist may have access to a content management console (“CMC”). Available “tabs” or “interactables” in the CMC may include, for example and without limitation, one or more of the following:
a. Asset management
   i. Uploading content
   ii. Uploading/updating metadata associated with content
   iii. Number and price of shares per asset. For example, when an asset is originally created and associated tokens are minted, a price for each token may not yet be associated with the token. When tokens are traded between investors, however, traded token (and/or share) prices may be recorded and viewed in connection with managing the asset.
   iv. Time period of availability (make an asset available for only a certain amount of time if wanted)
   v. Manage public and non-public uploaded assets
   vi. Create URLs and links from uploaded assets
b. Asset tracking
   i. Upload status
   ii. Streaming numbers per made-public asset
   iii. Share value increase/decrease through time
   iv. Playback of their own uploaded assets through a built-in media player
   v. Customizable playlist creation option for playback
   vi. Tracking number of clicks, leading users to other websites (Instagram, Facebook, Spotify, etc.)
c. Customizable personal profile management/editing
   i. Includes information about the artists uploading music
   ii. Can include links to supplementary content like Instagram, Facebook, Spotify, etc.
   iii. Includes links to their assets catalogues which consumers can click on to purchase and stream

The artist may upload their asset, which may be processed/packaged in the backend of the content distribution service. The artist may then make their uploaded assets available to consumers. A URL and/or other suitable link may be created per asset, which the artist may share. The artist may optionally create promotional content (e.g., Instagram “Reel” or posts, Instagram LinkTree, Facebook post, Tweets, YouTube video, snaps, physical posters to live events or launch parties, tickets through ticketing services, advertisements, etc.). The URL and/or link may be posted onto and/or in conjunction with their promotional content (e.g., via a URL website link, QR code, interactive ad, etc.

Examples of Consumer Interaction(s) with a Content Distribution Service

Non-limiting examples of consumer interactions with a content distribution service and/or related systems and/or services are detailed below.

A consumer may see a promotional video online through social media outlets, where an artist asks for support, promotes ticket sales, or advertises new merchandise. The consumer may click on the link, scan the QR code, or read an NFC chip, which may lead them to the content distribution service website/application. The consumer may create a content distributions service account, logging in via an appropriate interface (potentially via a SSO interface).

When creating an account, the consumer may be provided with a profiling questionnaire, asking them, for example and without limitation, one or more of:
What music genres do they listen to?
Who are their favorite artists?
Are they themselves musicians, if yes what do they play?
Do they intend to upload music onto the content distribution system?

The consumer may have access to a CMC, with one or more of the following non-limiting available tabs and/or interactables:
Asset marketplace
   Based on the profiling questionnaire (and eventually, maybe a more robust Al that can profile a user more efficiently), catalogues and assets available for purchase are displayed
   For artists, the option to “Support” them is available through a subscription fee, and/or a credit system
   An “explore” tab where new offers/releases are made available
   The consumer can choose to preview and add songs to their playlists without monetary commitment (similar to how one would add a song on Spotify)
A “My Playlists” tab
   Customizable playlists from collected songs are made available
   Interactive and customizable media player
   The option to play and stream the “free” non-encrypted assets is available (i.e. the user gets no reward for listening to the songs through the content distribution service, but the artists who uploaded it receives revenue from the streams)
   The “paid for” songs through subscription are also mixed into the playlists (i.e. the user gets rewarded for any additional streams as well as the original artists through fractional ownership)
A “Track my Assets” tab
   A stock-market exchange-like interface displays the current market value of purchased fractional shares
   Can also display the top trending artists & songs with their respective values
A “SuperTicket” tab
   Upcoming live events nearby or from followed artists may be displayed
   Live recordings of events are made available
   Collected merchandise or assets are displayed here as well

Users can preview, download, add to playlists, and/or the like, assets of their choosing. In some implementations, if they do not pay for an asset, then a “preview” asset may be streamed. If they pay for the asset, they can listen to the “actual” asset, managed by the blockchain.

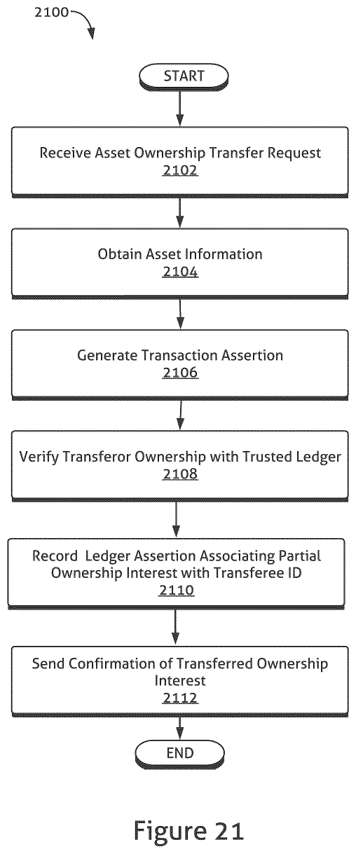

FIG. 21 illustrates a flow chart of a non-limiting example of a method 2100 of managing a digital asset consistent with certain embodiments of the present disclosure. The illustrated method 2100 may be implemented in a variety of ways, including using software, firmware, hardware, and/or any combination thereof. In certain embodiments, various aspects of the method 1000 and/or its constituent steps may be performed by a service, system, and/or device configured to implement embodiments of a TRM service (and/or associated services such as a marketplace service, blockchain connector service (which may be more generally described as a ledger connector service), a DB service, and/or any other suitable application, device, system and/or service or combination of applications, devices, systems, and/or services.

At 2102, a TRM service may receive from a marketplace service an asset ownership transfer request. The asset ownership transfer request may comprise a variety of information including, for example and without limitation, one or more of a transferor ID, a transferee ID, and an asset ID. Using the asset ID, an investor ID associated with the asset may be obtained at 2104 from a DB service managing a table indicating ownership information associated with one or more assets. In some embodiments, the investor ID may be associated with partial ownership of the digital asset.

A transaction assertion may be generated at 2106, which in some embodiments may be digitally signed by a key associated with the TRM service. In some embodiments, the transaction assertion may be generated using a ledger connection service. The transaction assertion may be generated based on one or more of the transferor ID, the transferee ID, and/or the investor ID. In various embodiments, the transaction assertion may comprise one or more hash values.

At 2108, the TRM service may verify, using the ledger connector service, that a trusted ledger, which may comprise a blockchain and/or a TIDAL, includes certain previously recorded assertions. For example, the ledger connector service may verify that verifying, using the ledger connector service, that a trusted ledger includes at least one recorded assertion associating the transferor identifier with the asset identifier and at least one recorded assertion associating the investor identifier with the transferor identifier. In this manner, the ledger connector service may verify that an entity associated with transferor ID has at least partial ownership interest in the asset.

In response to the verification, at 2110, the ledger connection service may record at least one assertion in the trusted ledger associating the transferee ID with the investor ID. In this manner, the ownership interest associated with the investor ID may be transferred to the transferee ID. A confirmation of the transferred ownership interest may be sent to the marketplace service and/or other parties indicating the successful transfer of ownership of the asset at 2112.

Example System and/or Service Architecture
System and/or Service Architecture

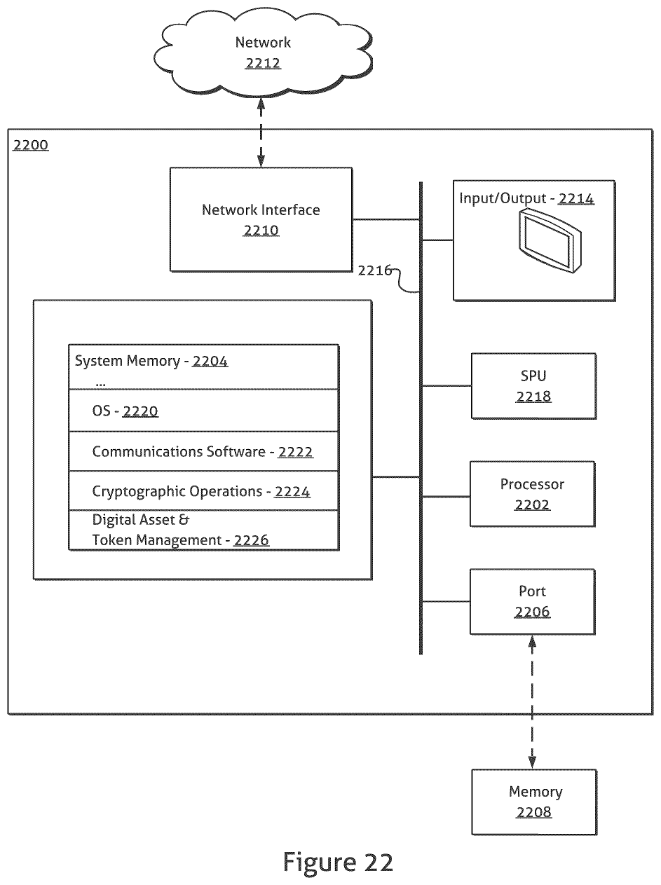

FIG. 22 illustrates a non-limiting example of a system 2200 that may be used to implement certain embodiments of the systems and methods of the present disclosure. The system 2200 of FIG. 22 and/or aspects thereof may be included in a system, service, and/or device associated with an owner, an ORH, a consumer, a buyer, a renter, a marketplace service, a TRM service, a trusted data management platform service, a TIDAL and/or an associated service, a DRM and/or KMS service, a DB, a file storage service, a payment gateway service, a wallet service, a blockchain service, a media packager service, an orchestrator service, a content distribution service, an event indexer service, a blockchain connector service, and/or any other service, which may comprise a trusted service, system, and/or component configured to implement embodiments of the disclosed systems and methods and/or aspects thereof.

The various systems and/or devices used in connection with aspects the disclosed embodiments may be communicatively coupled using a variety of networks and/or network connections (e.g., network 2212). In certain embodiments, the network 2212 may comprise a variety of network communication devices and/or channels and may utilize any suitable communications protocols and/or standards facilitating communication between the systems and/or devices. The network 2212 may comprise the Internet, a local area network, a virtual private network, and/or any other communication network utilizing one or more electronic communication technologies and/or standards (e.g., Ethernet or the like). In some embodiments, the network 2212 may comprise a wireless carrier system such as a personal communications system (“PCS”), and/or any other suitable communication system incorporating any suitable communication standards and/or protocols. In further embodiments, the network 2212 may comprise an analog mobile communications network and/or a digital mobile communications network utilizing, for example, code division multiple access (“CDMA”), Global System for Mobile Communications or Groupe Special Mobile (“GSM”), frequency division multiple access (“FDMA”), and/or time divisional multiple access (“TDMA”) standards. In certain embodiments, the network 2212 may incorporate one or more satellite communication links. In yet further embodiments, the network 2212 may utilize IEEE's 802.11 standards, Bluetooth®, ultra-wide band (“UWB”), Zigbee®, and or any other suitable standard or standards.

The various systems and/or devices used in connection with aspects of the disclosed embodiments may comprise a variety of computing devices and/or systems, including any computing system or systems suitable to implement the systems and methods disclosed herein. For example, the connected devices and/or systems may comprise a variety of computing devices and systems, including laptop computer systems, desktop computer systems, server computer systems, distributed computer systems, smartphones, tablet computers, and/or the like.

In certain embodiments, the systems and/or devices may comprise at least one processor system configured to execute instructions stored on an associated non-transitory computer-readable storage medium. As discussed in more detail below, systems used in connection with implementing various aspects of the disclosed embodiments may further comprise a secure processing unit (“SPU”) configured to perform sensitive operations such as trusted credential and/or key management, cryptographic operations, secure policy management, and/or other aspects of the systems and methods disclosed herein. The systems and/or devices may further comprise software and/or hardware configured to enable electronic communication of information between the devices and/or systems via a network using any suitable communication technology and/or standard.

As illustrated in FIG. 22, the example system 2200 may comprise: a processing unit 2202; system memory 2204, which may include high speed random access memory (“RAM”), non-volatile memory (“ROM”), and/or one or more bulk non-volatile non-transitory computer-readable storage mediums (e.g., a hard disk, flash memory, etc.) for storing programs and other data for use and execution by the processing unit 2202; a port 2206 for interfacing with removable memory 608 that may include one or more diskettes, optical storage mediums (e.g., flash memory, thumb drives, USB dongles, compact discs, DVDs, etc.) and/or other non-transitory computer-readable storage mediums; a network interface 2210 for communicating with other systems via one or more network connections and/or networks 2212 using one or more communication technologies; a user interface 2214 that may include a display and/or one or more input/output devices such as, for example, a touchscreen, a keyboard, a mouse, a track pad, and the like; and one or more busses 2216 for communicatively coupling the elements of the system.

In some embodiments, the system 2200 may, alternatively or in addition, include a trusted execution environment and/or an SPU 2218 that is protected from tampering by a user of the system or other entities by utilizing secure physical and/or virtual security techniques. A trusted execution environment and/or a SPU 2218 can help enhance the security of sensitive operations such as personal information management, trusted credential, token, and/or key management, privacy and policy management, and other aspects of the systems and methods disclosed herein. In certain embodiments, the trusted execution environment and/or SPU 2218 may operate in a logically secure processing domain and be configured to protect and operate on secret information, as described herein. In some embodiments, the trusted execution environment and/or a SPU 2218 may include internal memory storing executable instructions or programs configured to enable the SPU 2218 to perform secure operations, as described herein.

The operation of the system 2200 may be generally controlled by the processing unit 2202 and/or an SPU 2218 operating by executing software instructions and programs stored in the system memory 2204 (and/or other computer-readable media, such as memory 2208, which may be removable). The system memory 2204 may store a variety of executable programs or modules for controlling the operation of the system. For example, the system memory may include an operating system (“OS”) 2220 that may manage and coordinate, at least in part, and/or system hardware resources and provide for common services for execution of various applications.

The system memory 2204 may further include, without limitation, communication software 2222 configured to enable in part communication with and by the system, one or more applications, a cryptographic operation module 2224 configured to perform various aspects of the disclosed embodiments (e.g., cryptographic key and hash generation operations, key management operations, etc.), one or more verification digital asset and/or token management modules 2226 configured to perform various aspects of the methods disclosed herein, and/or any other information, modules, and/or applications configured to implement embodiments of the systems and methods disclosed herein.

The systems and methods disclosed herein are not inherently related to any particular computer, electronic control unit, or other apparatus and may be implemented by a suitable combination of hardware, software, and/or firmware. Software implementations may include one or more computer programs comprising executable code/instructions that, when executed by a processor, may cause the processor to perform a method defined at least in part by the executable instructions. The computer program can be written in any form of programming language, including compiled or interpreted languages, and can be deployed in any form, including as a standalone program or as a module, component, subroutine, or other unit suitable for use in a computing environment. Further, a computer program can be deployed to be executed on one computer or on multiple computers at one site or distributed across multiple sites and interconnected by a communication network.

Software embodiments may be implemented as a computer program product that comprises a non-transitory storage medium configured to store computer programs and instructions, that when executed by a processor, are configured to cause the processor to perform a method according to the instructions. In certain embodiments, the non-transitory storage medium may take any form capable of storing processor-readable instructions on a non-transitory storage medium. A non-transitory storage medium may be embodied by a compact disk, digital-video disk, a magnetic disk, flash memory, integrated circuits, or any other non-transitory digital processing apparatus memory device.

Although the foregoing has been described in some detail for purposes of clarity, it will be apparent that certain changes and modifications may be made without departing from the principles thereof. It should be noted that there are many alternative ways of implementing both the systems and methods described herein. Accordingly, the present embodiments are to be considered as illustrative and not restrictive, and the invention is not to be limited to the details given herein but may be modified with the scope and equivalents of the appended claims.

1. A method for managing a digital asset performed by a token rights management service executing on a system comprising a processor and a non-transitory computer-readable storage medium storing instructions that, when executed by the processor, cause the system to perform the method, the method comprising:
receiving, from a marketplace service, an asset ownership transfer request, the asset ownership transfer request comprising a transferor identifier, a transferee identifier, and an asset identifier;
obtaining, using the asset identifier, an investor identifier associated with the asset, the investor identifier being associated with a partial ownership of the digital asset;
generating, using a ledger connector service, a transaction assertion, the transaction assertion being generated based on the transferor identifier, the transferee identifier, and the investor identifier;
verifying, using the ledger connector service, that a trusted ledger includes at least one recorded assertion associating the transferor identifier with the asset identifier and at least one recorded assertion associating the investor identifier with the transferor identifier;
recording, by the ledger connection service, in response to the verification, at least one assertion in the trusted ledger associating the transferee identifier with the investor identifier; and
sending, in response to the recording of the at least one assertion in the trusted ledger associating the transferee identifier with the investor identifier, at least one confirmation message to the marketplace service indicating a transfer of ownership of the digital asset.

2. The method of claim 1, wherein obtaining the investor identifier comprises querying a database service using the asset identifier to obtain the investor identifier from the database.

3. The method of claim 2, wherein the method further comprises updating an asset table managed by the database service.

4. The method of claim 1, wherein the at least one confirmation message indicates a transfer of the partial ownership of the digital asset.

5. The method of claim 1, wherein the ledger connector service comprises a service of the token rights management service.

6. The method of claim 1, wherein the trusted ledger comprises a blockchain ledger.

7. The method of claim 1, wherein the trusted ledger comprises a trusted immutable distributed assertion ledger.

8. The method of claim 1, wherein generating the transaction assertion further comprises signing the transaction assertion with a private key of the token rights management service.

9. The method of claim 1, wherein generating the transaction assertion comprises generating at least one hash value based on at least one of the transferor identifier, the transferee identifier, and the investor identifier.

10. The method of claim 1, wherein the at least one confirmation message comprises an indication of transfer of ownership of the digital asset to the transferee identifier.

11. The method of claim 1, wherein the partial ownership of the digital asset is expressed in terms of a number of owned tokens associated with the digital asset.

12. The method of claim 11, wherein the trusted ledger comprises at least one assertion associating the investor identifier with the number of owned tokens.

13. The method of claim 12, wherein the number of owned tokens comprises at least a subset of a total number of minted tokens associated with the digital asset.

14. The method of claim 1, wherein the partial ownership of the digital asset is expressed in terms of a percentage ownership of the digital asset.

15. The method of claim 1, wherein the ledger connection service comprises a subservice of the token rights management service.
